(19) United States
(12) Patent Application Publication
(10) Pub. No.: US 2025/0212015 A1
(43) Pub. Date: Jun. 26, 2025

(54) WIRELESS COMMUNICATION DEVICE AND SYSTEM

(71) Applicant: Intel Corporation, Santa Clara, CA (US)

(72) Inventors: Abhijith PRABHA, Piravom (IN); Nidhi P. SHETTY, Bangalore (IN); Madhukiran SRINIVASAREDDY, Bangalore (IN); Vamshi Krishna AAGIRU, Bangalore (IN); Maruti TAMRAKAR, Durg (IN); Jithin VALAPPILEKANDY, Bangalore (IN); Balvinder Pal SINGH, Bhilai (IN)

(21) Appl. No.: 18/389,882

(22) Filed: Dec. 20, 2023

(51) Int. Cl. H04W 16/28; H04W 48/16

(52) U.S. Cl. CPC H04W 16/28; H04W 48/16

(57) ABSTRACT

A wireless communication device configured to provide an omnidirectional transmission mode and a directional transmission mode, the wireless communication device comprising: a processor configured to: determine an orientation of a part of a body of a user of the wireless communication device; determine a scanning region of a transceiver of the wireless communication device based on the determined orientation; instruct the transceiver to operate in the directional transmission mode to scan the scanning region; and detect one or more other wireless communication devices based on the scanning of the scanning region.

### TECHNICAL FIELD

Various aspects of this disclosure generally relate to a wireless communication device and a system.

### BACKGROUND

Before establishing a connection with another wireless communication device, a user of a wireless communication device is conventionally presented a list of all other wireless communication devices around the wireless communication device. This may be bothersome since such a list may be long and contain devices not of interest to the user.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 shows an example of a scanning region;

FIG. 2 shows an example of switching a connection from one other wireless communication device to another other wireless communication device;

FIG. 3 shows an example of switching a connection from one other wireless communication device to another other wireless communication device;

FIG. 4 shows an example of switching a connection from one other wireless communication device to another other wireless communication device;

FIG. 5 shows an example of an advertising and scan response data format according to a Bluetooth standard;

FIG. 6 shows an example of a scan response with added vendor specific details;

FIG. 7 shows an example of switching a connection from one other wireless communication device to another other wireless communication device;

FIG. 8 shows an example of switching a connection from one other wireless communication device to another other wireless communication device;

FIG. 9 shows a wireless communication device in accordance with various aspects of the present disclosure;

FIG. 10 shows a system in accordance with various aspects of the present disclosure;

FIG. 11 shows steps of a method which a wireless communication device is configured to carry out in accordance with various aspects of the present disclosure;

FIG. 12a shows further steps of a method which a wireless communication device is configured to carry out in accordance with various aspects of the present disclosure;

FIG. 12b is a continuation of FIG. 12a;

FIG. 13 shows steps of a method which a system is configured to carry out in accordance with various aspects of the present disclosure;

FIG. 14a shows further steps of a method which a system is configured to carry out in accordance with various aspects of the present disclosure;

FIG. 14b is a continuation of FIG. 14a;

FIG. 15 shows steps of a method which a wireless communication device is configured to carry out in accordance with various aspects of the present disclosure;

FIG. 16a shows further steps of a method which a wireless communication device is configured to carry out in accordance with various aspects of the present disclosure;

FIG. 16b is a continuation of FIG. 16a;

FIG. 16c is a continuation of FIG. 16b;

FIG. 17 shows steps of a method which a wireless communication device is configured to carry out in accordance with various aspects of the present disclosure;

FIG. 18a shows further steps of a method which a wireless communication device is configured to carry out in accordance with various aspects of the present disclosure;

FIG. 18b is a continuation of FIG. 18a;

FIG. 18c is a continuation of FIG. 18b.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

As used herein, “wireless communication device” may refer to any type of electronic devices that are able to exchange information with at least another device, for example according to various types of radio communication technologies and using various types of communication protocols as exemplarily provided herein. Exemplarily, a wireless communication device may be, or may include, an access point, a station, any types of user devices which may include a suitable device including a processor, that may include, a mobile device or a non-mobile device, a user equipment (UE), a computing device, such as a personal computer (PC), a desktop computer, a mobile computer, a laptop computer, a notebook computer, a tablet computer, a server, a handheld computing device, a wearable device, such as a smart bracelet, a smart watch, smart glasses, a smart ring, etc., an internet of things (IoT) device, a sensor, a mobile phone, a cellular telephone, any types of wireless accessories, such as a headphone, a headset, a microphone, a speaker, a domotics (smart home) device, a docking station, a medical device, an endoscope, a surgical robot, a hearing aid, a cochlear implant device or a system, a Bluetooth medical device, an audio communication device, a headset, a headphone, an earphone, an earbud, a true wireless earphone, a wireless speaker, an in-vehicle device, or a device for vehicles, etc.

The apparatuses and methods of this disclosure may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 5G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHZ and further frequencies), and may use various spectrum bands including, but not limited to, IMT (International Mobile Telecommunications) spectrum (including 450-470 MHz, 790 960 MHz, 1710 2025 MHz, 2110-2200 MHZ, 2300-2400 MHZ, 2500-2690 MHz, 698 790 MHz, 610 790 MHz, 3400 3600 MHZ, etc., where some bands may be limited to specific region(s) and/or countries), IMT advanced spectrum, IMT-2020 spectrum (expected to include 3600 3800 MHZ, 3.5 GHz bands, 700 MHz bands, bands within the 24.25 86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHZ, 57-64 GHz, 64-71 GHz, 71-76 GHZ, 81-86 GHz and 92-94 GHz, etc.), the ITS (Intelligent Transport Systems) band of 5.9 GHz (typically 5.85 5.925 GHz) and 63 64 GHz, bands currently allocated to WiGig such as WiGig Band 1 (57.24 59.40 GHz), WiGig Band 2 (59.40 61.56 GHZ) and WiGig Band 3 (61.56 63.72 GHZ) and WiGig Band 4 (63.72 65.88 GHZ), the 70.2 GHZ-71 GHz band, any band between 65.88 GHz and 71 GHz, bands currently allocated to automotive radar applications such as 76 81 GHZ, and future bands including 94 300 GHz and above. Furthermore, the apparatuses and methods described herein can also employ radio communication technologies on a secondary basis on bands such as the TV White Space bands (typically below 790 MHz) where e.g. the 400 MHz and 700 MHz bands are prospective candidates. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier 1 users, followed by tier 2, then tier 3, etc. users, etc. The apparatuses and methods described herein can also use radio communication technologies with different Single Carrier or OFDM flavors (CP OFDM, SC FDMA, SC OFDM, filter bank-based multicarrier (FBMC), OFDMA, etc.) and e.g. 3GPP NR (New Radio), which can include allocating the OFDM carrier data bit vectors to the corresponding symbol resources.

For purposes of this disclosure, radio communication technologies may be classified as one of a Short Range radio communication technology or Cellular Wide Area radio communication technology. Short Range radio communication technologies may include Bluetooth, WLAN/WiFi (e.g., according to any IEEE 802.11 standard), and other similar radio communication technologies including Wireless Personal Area Network (WPAN) standards (e.g., according to any IEEE 802.15 standard), Wi-Fi Direct, Cellular Wide Area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. Cellular Wide Area radio communication technologies may be generally referred to herein as “cellular” communication technologies.

Bluetooth (BT) technology may use frequencies between 2.402 and 2.480 GHz, or 2.400 and 2.4835 GHz including guard bands 2 MHz wide at the bottom end and 3.5 MHz wide at the top, according to frequency-hopping spread spectrum. A wireless communication device operating according to a Bluetooth protocol may divide data to be transmitted into packets, and transmit each packet into a channel designated for the use (e.g. of bandwidth of 1 MHz for classic Bluetooth and 2 MHz for Bluetooth Low Energy (BLE)). A wireless communication device configured to operate according to a Bluetooth protocol may operate in a basic rate (BR) mode using a Gaussian frequency-shift keying (GFSK) modulation, and/or operate in an enhanced data rate (EDR) mode, that is considered to provide a faster data rate and lower power consumption, using a differential phase-shift keying (DPSK) (e.g. 8-DPSK) and/or differential quadrature phase-shift keying (DQPSK) (e.g. π/4-DQPSK) based on the quality of the communication channel. A wireless communication device configured to operate according to a Bluetooth protocol may operate according to the Bluetooth Low Energy (BLE) technology that is integrated within the Bluetooth standard starting from v4.0, which operates within the same frequency spectrum, using GFSK modulation.

Wi-Fi Direct technology, which may also be referred to as Wi-Fi P2P, may be one of the exemplary technologies used with respect to peer-to-peer connections provided in this disclosure. Peer-to-peer connections may refer to point-to-point connections between two communication devices according to a peer-to-peer communication protocol. Within a peer-to-peer network, wireless communication devices (two or more) may communicate with each other over the P2P connections established between them. A Wi-Fi Direct connection may allow wireless communication devices to communicate over an established Wi-Fi Direct connection without an intermediary entity such as an access point or a router. Wi-Fi Direct technology allows for forming a P2P network by forming a P2P group in which a communication device may take the role of a Group Owner (GO) or a Group Client (GC).

A Bluetooth standard according to aspects of the disclosure may be a Bluetooth V 1.0A/1.0B standard, Bluetooth V 1.1 standard, Bluetooth V 1.2 standard, Bluetooth V 2.0 standard (optionally plus EDR (Enhanced Data Rate), Bluetooth V 2.1 standard (optionally plus EDR (Enhanced Data Rate), Bluetooth V 3.0 standard, Bluetooth V 4.0 standard, Bluetooth V 4.1 standard, Bluetooth V 4.2 standard, Bluetooth V 5.0 standard, Bluetooth V 5.1 standard, Bluetooth V 5.2 standard, and the like.

According to aspects of the disclosure, a wireless communication device may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.11ax, and/or IEEE P802.11be standards and/or proposed specifications for WLANs, although the scope of the disclosure is not limited in this respect.

According to aspects of the disclosure, a wireless communication device may be configured for high-efficiency (HE) Wi-Fi (HEW) communications in accordance with the IEEE 802.11ax standard. According to aspects of the disclosure, a wireless communication device may be configured for Extremely High Throughput (EHT) communications in accordance with the IEEE 802.11be standard. According to aspects of the disclosure, a wireless communication device may be configured to communicate in accordance with an OFDMA technique, although the scope of the disclosure is not limited in this respect.

According to some IEEE 802.11 aspects, a wireless communication device may be configured for communication over various channel bandwidths including bandwidths having center frequencies of about 900 MHZ, 2.4 GHz, 5 GHZ, and bandwidths of about 1 MHz, 2 MHZ, 2.5 MHz, 4 MHz, 5 MHz, 8 MHz, 10 MHz, 16 MHz, 20 MHz, 40 MHZ, 80 MHz (with contiguous bandwidths) or 80+80 MHz (160 MHz) (with non-contiguous bandwidths). In some aspects, a 320 MHz channel bandwidth may be used. The scope of the aspects is not limited with respect to the above center frequencies however.

A WiFi standard as referred to in this disclosure may be a IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). Further, a WiFi standard as referred to in this disclosure may be one or more of IEEE 802.11 a/b/g/n/ac/ad/af/ah/aj/ay.

According to aspects of the disclosure, there is provided a wireless communication device and a system which generally allow for the finding, identification and/or tracking of one or more other wireless communication devices as well as for the establishment of a connection to one or more other wireless communication devices, e.g., by setting a search/scanning region based on an orientation of a part of a body of a user of the wireless communication device. To this end, the wireless communication device (e.g., a transceiver thereof) and/or the system (e.g., a wireless communication device thereof, e.g., a transceiver thereof) may be operated in a directional transmission mode with a reduced radio coverage as compared to an omnidirectional transmission mode. Thereby, a number of detected one or more other wireless communication devices may be reduced and the user may more easily find, identify and/or track the one or more other wireless communication devices as well as establish a connection to the one or more other wireless communication devices.

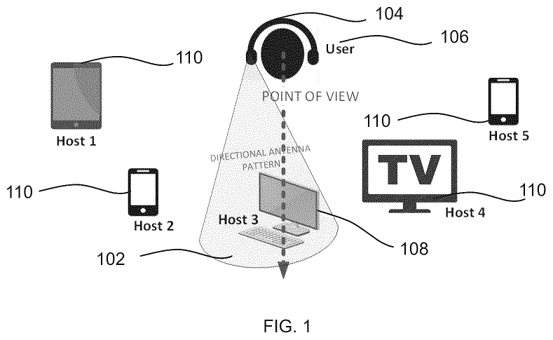

FIG. 1 shows an example of a scanning region 102. As shown in FIG. 1, a processor (e.g., a processor 902, 1004) according to aspects of the disclosure may be configured to determine a scanning region 102 of a transceiver (e.g., a transceiver 906, 1054) of a wireless communication device 104 (e.g., a wireless communication device 900, e.g., a wireless communication device 1002) based on an orientation of a part of a body of a user 106 of the wireless communication device 104 (e.g., based on an orientation of headphones worn by the user 106). Illustratively, the user 106 implicitly, using a part of his body, such as his head, arm, fingers and the like, or indirectly using a device worn by the user 106, indicates a direction which the processor (e.g., the processor 902, 1004) will determine and use to control the scanning region 102. Here, the processor (e.g., the processor 902, 1004) according to aspects of the disclosure may be configured to detect one or more other wireless communication devices 108 (e.g., a computer) based on scanning of the scanning region 102 (e.g., i.e., the one or more other wireless communication devices 108 present in the scanning region 102), which the user 106 indicates using a portion of his/her body. Further, the processor (e.g., the processor 902, 1004) according to as aspects of the disclosure may be configured not to detect one or more other wireless communication devices 110 based on scanning of the scanning region 102 which are outside the scanning region 102.

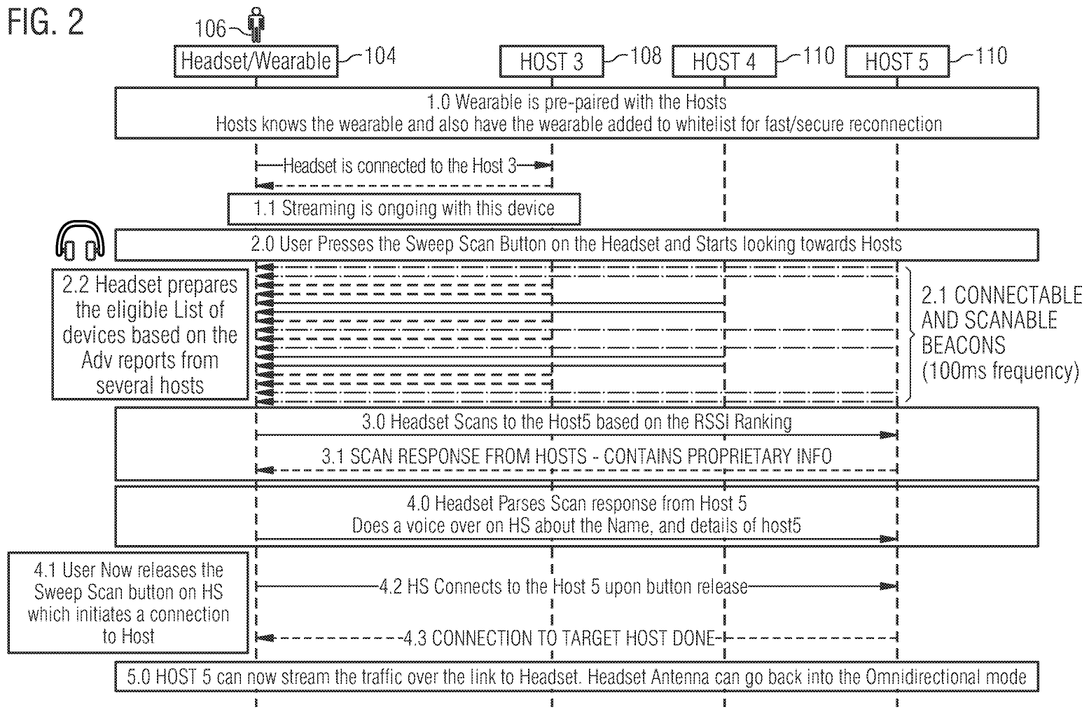

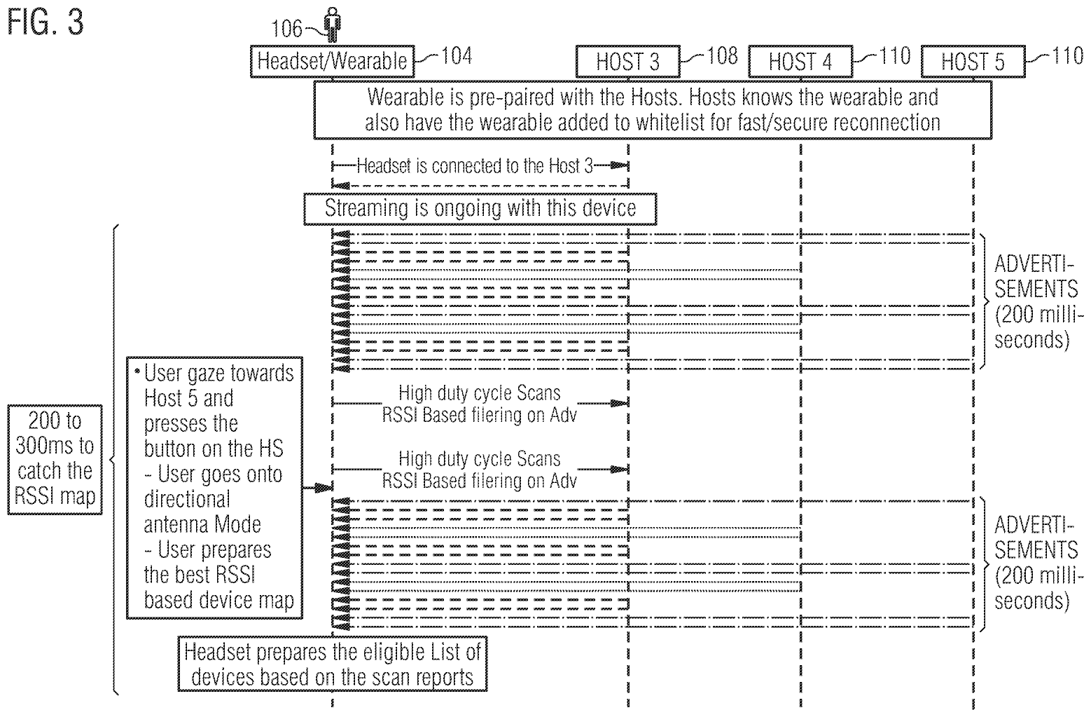

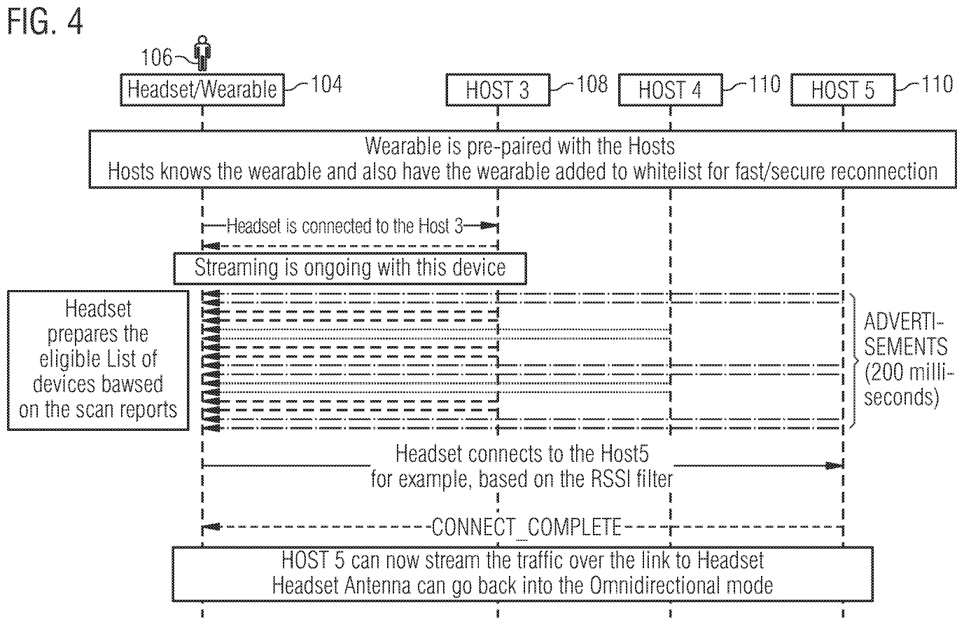

FIG. 2 shows an example of switching a connection from one other wireless communication device 108 to another other wireless communication device 110; FIG. 3 shows an example of switching a connection from one other wireless communication device 108 to another other wireless communication device 110; and FIG. 4 shows an example of switching a connection from one other wireless communication device 108 to another other wireless communication device 110. As shown in FIG. 2, FIG. 3, and

FIG. 4, a wireless communication device 104 (here, “Wearable/Headset”) of a user 106 may be pre-paired with one or more other wireless communication devices 108, 110 (here, “HOST 3”, “HOST 4”, “HOST 5”) (1.0 in FIG. 2). Further, the wireless communication device 104 (here, “Wearable/Headset”) may be connected to one of the one or more other wireless communication devices 108 (here, “HOST 3”) and streaming may be ongoing between the wireless communication device 104 (here, “Wearable/Headset”) and the one of the one or more other wireless communication devices 108 (here, “HOST 3”) (1.1 in FIG. 2). The user 106 may press a sweep scan button and may start looking towards one or more other wireless communication devices 110 (2.0 in FIG. 2). That is, the processor of the wireless communication device 104 may be configured to receive a start trigger, and the processor of the wireless communication device 104 may be configured to determine an orientation of a part of a body of the user 106 of the wireless communication device 104; determine a scanning region of a transceiver based on the determined orientation; and instruct the transceiver to operate in the directional transmission mode to scan the scanning region. Further, the processor may be configured to determine one or more signal strengths by determining a Received Signal Strength Indicator of a signal received from one or more of the detected one or more other wireless communication devices 110 (3.0, 3.1 in FIG. 2), and the processor may be configured to instruct the wireless communication device 104 to output the detected one or more other wireless communication devices 110 and the associated determined signal strength for each of the detected one or more other wireless communication devices 110 (here, “HOST 5”) (4.0 in FIG. 2). Further, the user 106 may release the sweep scan button (4.1). That is, the processor may be configured to receive a stop trigger; and, upon receipt of the stop trigger, establish the wireless connection between the wireless communication device 104 and the one of the other wireless communication devices 110 (here, “HOST 5”) (4.2, 4.3 in FIG. 2). Further, the processor may be configured to, upon receipt of the stop trigger, instruct the transceiver to operate in the omnidirectional transmission mode (5.0 in FIG. 2).

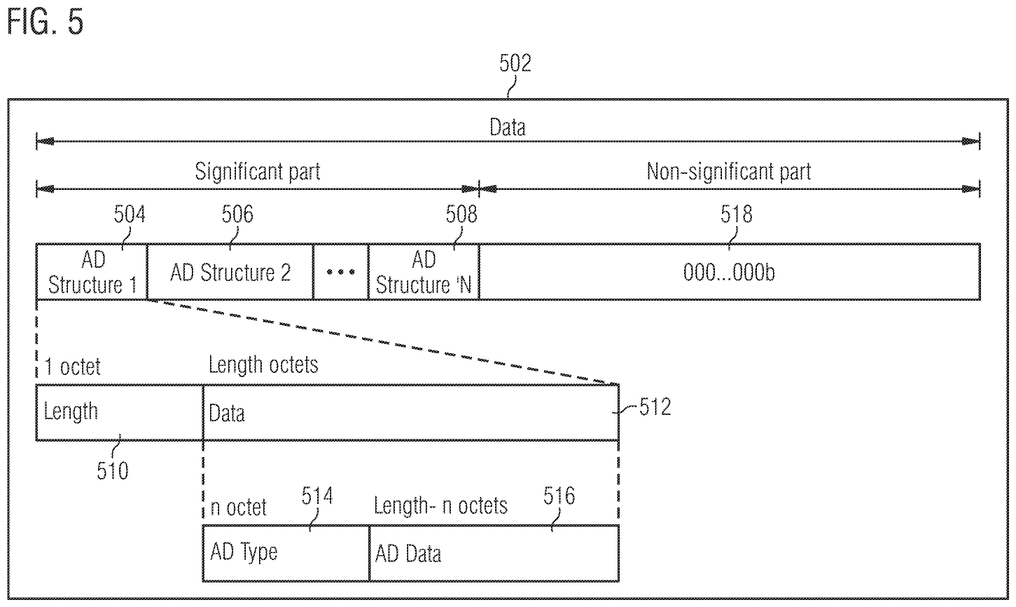

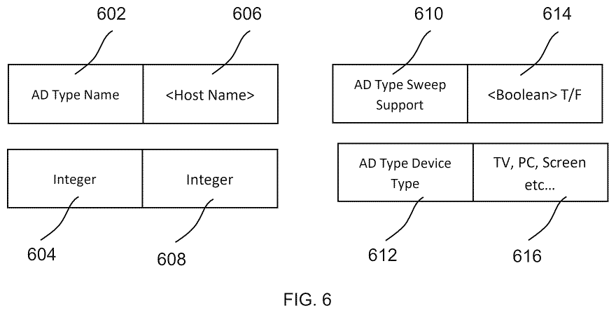

FIG. 5 shows an example of an advertising and scan response data format 502 according to a Bluetooth standard, and FIG. 6 shows an example of a scan response with added vendor specific details 610, 612, 614, 616. According to aspects of the disclosure, a signal received from one or more of the detected one or more other wireless communication devices may be a beacon message 502 from one or more of detected one or more other wireless communication devices. Here, a corresponding beacon message 502 may be according to the example shown in FIG. 5. In particular, the beacon message 502 may comprise various AD structures 506, 508 in a significant part. Further, the beacon message 502 may also comprise a non-significant part 518. An AD structure 506 may have a length 510 as well as data 512. Here, the data 512 may comprise an AD type 512 and AD data 516. Further, as shown in FIG. 6, the corresponding beacon (e.g., the corresponding beacon message 502) may further comprise vendor specific details 610, 612, 614, 616 (e.g., a type of the one or more other wireless communication devices 612, 616, e.g., information whether an establishment of a connection according to aspects of the disclosure is possible 610, 614). In this respect, according to aspects of the disclosure, a processor as described in this application may be configured to instruct the wireless communication device to output the detected one or more other wireless communication devices to the user, e.g., including vendor specific details 610, 612, 614, 616.

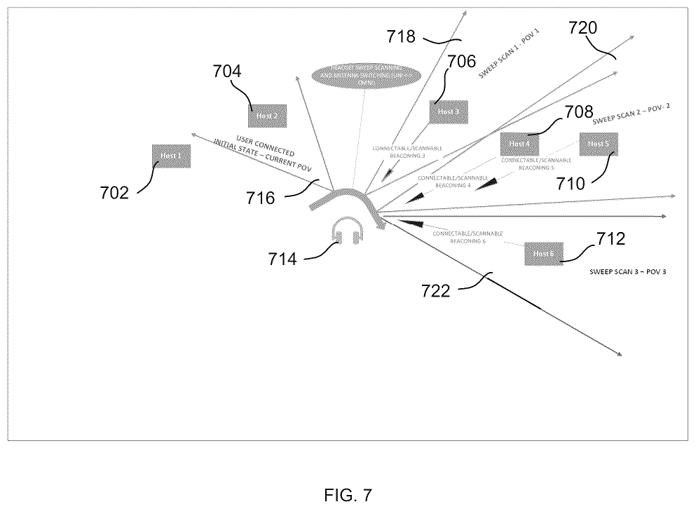

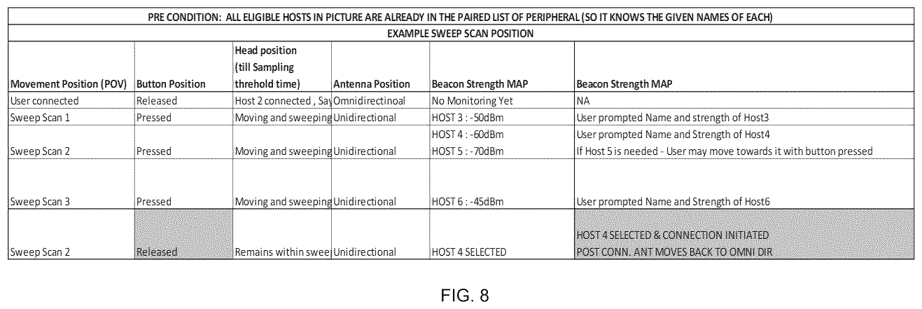

FIG. 7 shows an example of switching a connection from one other wireless communication device 704 (here, “HOST 2”) to another other wireless communication device 708 (here, “HOST 4”); and FIG. 8 shows an example of switching a connection from one other wireless communication device 704 (here, “HOST 2”) to another other wireless communication device 708 (here, “HOST 4”). As shown in FIG. 7 and FIG. 8, a wireless communication device 714 (here, “headphones”) may initially be connected to one of one or more other wireless communications devices 704 (here, “Host 2). Further, the processor may be configured to: receive a start trigger (here, “Button Position: Pressed”); and upon receipt of the start trigger: determine an orientation of a part of the body of the user of the wireless communication device 714; determine a scanning region 718 of the transceiver based on the determined orientation; instruct the transceiver to operate in the directional transmission mode to scan the scanning region 718; and detect the one or more other wireless communication devices 706 based on the scanning of the scanning region 718. Specifically, the processor may be configured to detect one or more other wireless communication devices 706 (here, “Host 3”) based on the scanning of the scanning region 718, determine a signal strength of a signal received from one or more of the detected one or more other wireless communication devices 706 (here, “Host 3”); determine one or more other detected wireless communication devices 706 (here, “Host 3”) based on the one or more determined signal strengths by determining a Received Signal Strength Indicator of a signal received from one or more of the detected one or more other wireless communication devices 706 (here, “Host 3”); and instruct the wireless communication device 714 to output the detected one or more other wireless communication devices 706 (here, “Host 3”) and the associated determined signal strength for each of the detected one or more other wireless communication devices 706 (here, “Host 3”). Further, the user may move and/or change a point of view, and the processor may be configured to detect one or more other wireless communication devices 708, 710 (here, “Host 4” and “Host 5”) based on the scanning of the scanning region 720, determine a signal strength of a signal received from one or more of the detected one or more other wireless communication devices 708, 710 (here, “Host 4” and “Host 5”); determine one or more other detected wireless communication devices 708, 710 (here, “Host 4” and “Host 5”) based on the one or more determined signal strengths by determining a Received Signal Strength Indicator of a signal received from one or more of the detected one or more other wireless communication devices 708, 710 (here, “Host 4” and “Host 5”); and instruct the wireless communication device 714 to output the detected one or more other wireless communication devices 708, 710 (here, “Host 4” and “Host 5”) and the associated determined signal strength for each of the detected one or more other wireless communication devices 708, 710 (here, “Host 4” and “Host 5”).

Here, the processor may be configured to select one of the detected one or more other wireless communication devices 708 (here, “Host 4”) based on the determined signal strengths (e.g., based on a strongest determined signal strength); and establish a wireless connection between the wireless communication device 714 and the one of the other wireless communication devices 708 by establishing a wireless connection between the wireless communication device 714 and the selected one of the detected one or more other wireless communication devices 708. However, the user might, e.g., approach another one 710 (here, “Host 5”) of the one or more other wireless communication devices and move away from the other wireless communication device 708 (here, “Host 4”) to shift the determined signal strength of the other wireless communication device 708 (here, “Host 4”) to a strongest signal strength. Further, the user may move and/or change a point of view, and the processor may be configured to detect one or more other wireless communication devices 712 based on the scanning of the scanning region 722 (here, “Host 6”), determine a signal strength of a signal received from one or more of the detected one or more other wireless communication devices 712 (here, “Host 6”); determine one or more other detected wireless communication devices 712 (here, “Host 6”) based on the one or more determined signal strengths by determining a Received Signal Strength Indicator of a signal received from one or more of the detected one or more other wireless communication devices 712 (here, “Host 6”); and instruct the wireless communication device 714 to output the detected one or more other wireless communication devices 712 (here, “Host 6”) and the associated determined signal strength for each of the detected one or more other wireless communication devices 712 (here, “Host 6”). Further, the user may move and/or change a point of view, and the processor may be configured to detect one or more other wireless communication devices 708 (here, “Host 4”) based on the scanning of the scanning region 720, determine a signal strength of a signal received from one or more of the detected one or more other wireless communication devices 708 (here, “Host 4”); determine one or more other detected wireless communication devices 708 (here, “Host 4”) based on the one or more determined signal strengths by determining a Received Signal Strength Indicator of a signal received from one or more of the detected one or more other wireless communication devices 708 (here, “Host 4”); and instruct the wireless communication device 714 to output the detected one or more other wireless communication devices 708 (here, “Host 4”) and the associated determined signal strength for each of the detected one or more other wireless communication devices 708 (here, “Host 4”). Further, the processor may be configured to detect an input from the user (here “Button Position: Released”); select one of the detected one or more other wireless communication devices 708 (here, “Host 4”) based on the detected input from the user; and establish the wireless connection between the wireless communication device 714 and the one of the other wireless communication devices 708 (here, “Host 4”) by establishing a wireless connection between the wireless communication device 714 and the selected one of the detected one or more other wireless communication devices 708 (here, “Host 4”).

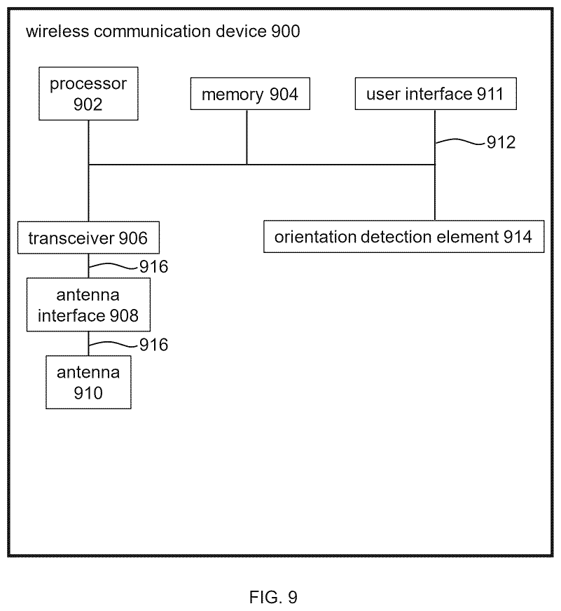

FIG. 9 shows a wireless communication device 900 in accordance with various aspects of the present disclosure. As shown in FIG. 9, a wireless communication device 900 may include: a processor 902, a memory 902, a transceiver 906, an antenna interface 908, an antenna 910, and a user interface 911. The processor 902, the memory 902, the transceiver 906, and/or the user interface 911 may be coupled via a communication bus 912. The transceiver 906, the antenna interface 908 and the antenna 910 may be coupled via an antenna connection 916. The antenna 910 and the transceiver 906 may be coupled, e.g., for the transmission of radio signals, e.g., via the antenna interface 108. The wireless communication device 900 (e.g., the transceiver 906) may be configured to operate according to a Bluetooth standard and/or a WiFi standard as described above. The wireless communication device 900 (e.g., the transceiver 906) may be configured to provide an omnidirectional transmission mode and a directional transmission mode. The transceiver 906 may be configured to control the antenna 910 to transmit or receive signals in the omnidirectional transmission mode or in the directional transmission mode. The antenna 910 may, e.g., be a MIMO antenna array which may be configured to adjust its directivity and, thereby, provide the omnidirectional transmission mode and the directional transmission mode in a selective manner.

The user interface 911 may include a hardware button, a soft button, a touchscreen display including a button displayed thereon, a multi-functional (soft/hardware/touchscreen display) button including various functions, e.g., depending on a sequence in which it is operated, and/or a combination thereof.

Further, the wireless communication device 900 may include an orientation detection element 914. The orientation detection element 914 may be coupled to processor 902 via the communication bus 912. The orientation detection element 914 may be configured to obtain signals representing an orientation of a part of a body of a user of the wireless communication device 900. The orientation detection element 914 may, e.g., include a camera and/or any sensor capable of tracking a device representative for an orientation of a part of a body of a user of the wireless communication device 900.

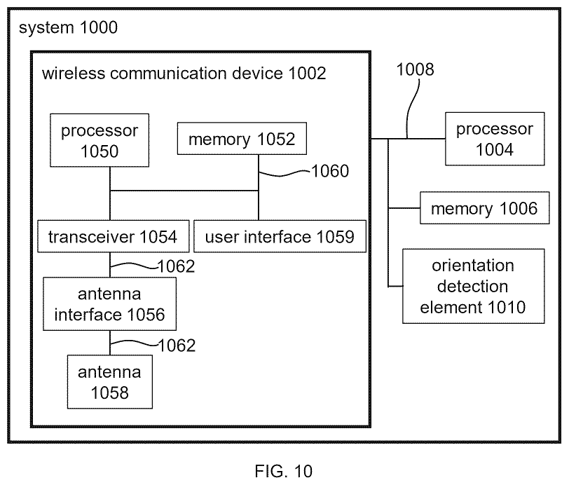

FIG. 10 shows a system in accordance with various aspects of the present disclosure. As shown in FIG. 10, a system 1000 according to aspects of the disclosure may include: a wireless communication device 1002, a processor 1004 and a memory 1006. The wireless communication device 1002, the processor 1004, and/or the memory 1006 may be coupled via a communication connection 1008. The wireless communication device 1002 may include: a processor 1050, a memory 1052, a transceiver 1054, an antenna interface 1056, an antenna 1058, and a user interface 1059. The processor 1050, the memory 1052, the transceiver 1054, and/or the user interface 1059 may be coupled via a communication bus 1060. The transceiver 1054, the antenna interface 1056 and/or the antenna 1058 may be coupled via an antenna connection 1062. The transceiver 1054 may be configured to provide an omnidirectional transmission mode and a directional transmission mode. The antenna 1058 and the transceiver 1054 may be coupled, e.g., for the transmission of radio signals, e.g., via the antenna interface 1056. The wireless communication device 1002 (e.g., the transceiver 1054) may be configured to operate according to a Bluetooth standard and/or a WiFi standard as described above. The wireless communication device 1002 (e.g., the transceiver 1054) may be configured to provide an omnidirectional transmission mode and a directional transmission mode. The transceiver 1054 may be configured to control the antenna 1058 to transmit or receive signals in the omnidirectional transmission mode or in the directional transmission mode. The antenna 1058 may, e.g., be a MIMO antenna array which may be configured to adjust its directivity and, thereby, provide the omnidirectional transmission mode and the directional transmission mode in a selective manner.

The user interface 1059 may include a hardware button, a soft button, a touchscreen display including a button displayed thereon, a multi-functional (soft/hardware/touchscreen display) button including various functions, e.g., depending on a sequence in which it is operated, and/or a combination thereof.

Further, the system 1000 may include an orientation detection element 1010. The orientation detection element 1010 may be coupled to the processor 1004 via the communication connection 1008. The orientation detection element 1010 may be configured to obtain signals representing an orientation of a part of a body of a user of the wireless communication device 1002. The orientation detection element 1010 may, e.g., include a camera and/or any sensor capable of tracking a device representative for an orientation of a part of a body of a user of the wireless communication device 1002.

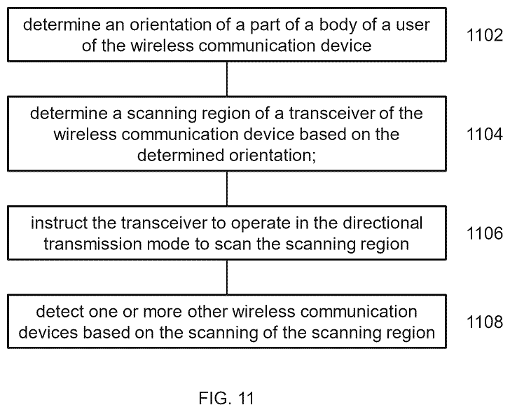

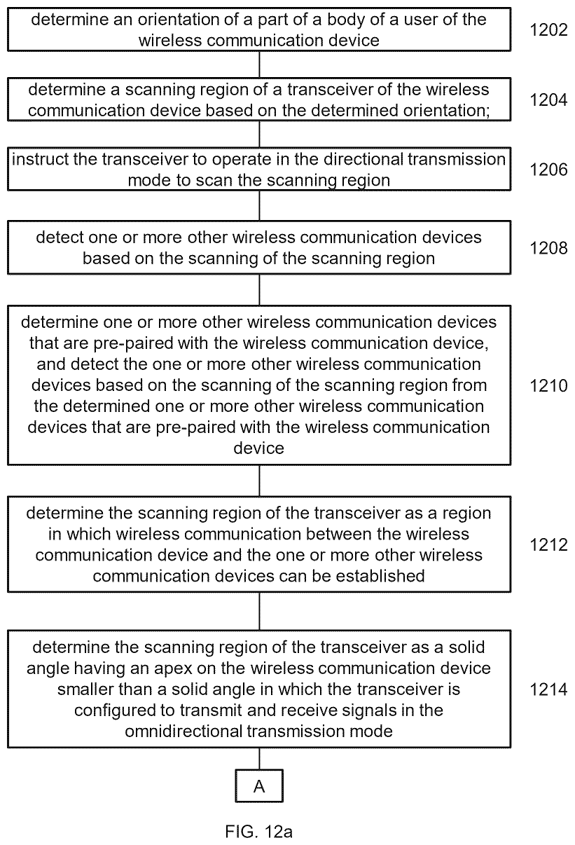

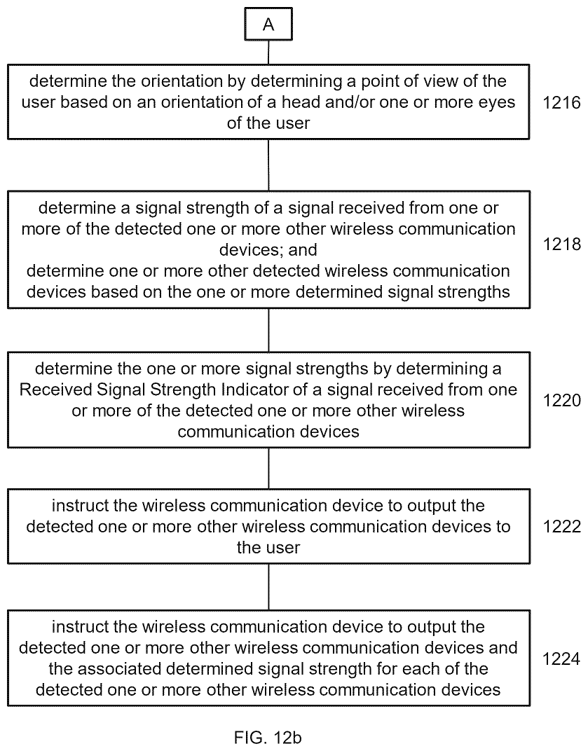

FIG. 11 shows steps of a method which a wireless communication device 900 is configured to carry out in accordance with various aspects of the present disclosure; FIG. 12a shows further steps of a method which the wireless communication device 900 is configured to carry out in accordance with various aspects of the present disclosure;

FIG. 12b is a continuation of FIG. 12a.

As shown in FIG. 11, the processor 902 of the wireless communication device 900 may be configured to: determine (1102) an orientation of a part of a body of a user of the wireless communication device 900; determine (1104) a scanning region of a transceiver 906 of the wireless communication device 900 based on the determined orientation; instruct (1106) the transceiver 906 to operate in the directional transmission mode to scan the scanning region; and detect (1108) one or more other wireless communication devices based on the scanning of the scanning region.

Alternatively, the processor 902 of the wireless communication device 900 may be configured to: determine an orientation of the wireless communication device 900 (e.g., when the wireless communication device is used as a pointer by a user of the wireless communication device); determine a scanning region of a transceiver 906 of the wireless communication device 900 based on the determined orientation; instruct the transceiver 906 to operate in the directional transmission mode to scan the scanning region; and detect one or more other wireless communication devices based on the scanning of the scanning region.

That is, in other words, the processor 902 of the wireless communication device 900 may, e.g., be configured to determine (1102) the orientation of the part of the body of the user of the wireless communication device 900 by determining an orientation of the wireless communication device 900.

As shown in FIG. 12a and FIG. 12b, the processor 902 of the wireless communication device 900 may firstly be configured as shown in FIG. 11, i.e., to: determine (1202) an orientation of a part of a body of a user of the wireless communication device 900; determine (1204) a scanning region of a transceiver 906 of the wireless communication device 900 based on the determined orientation; instruct (1206) the transceiver 906 to operate in the directional transmission mode to scan the scanning region; and detect (1208) one or more other wireless communication devices based on the scanning of the scanning region.

Further, the processor 902 of the wireless communication device 900 may be configured to: determine (1210) one or more other wireless communication devices that are pre-paired with the wireless communication device 900, and detect (1210) the one or more other wireless communication devices based on the scanning of the scanning region from the determined one or more other wireless communication devices that are pre-paired with the wireless communication device 900.

Further, the processor 902 of the wireless communication device 900 may be configured to: determine (1212) the scanning region of the transceiver 906 as a region in which wireless communication between the wireless communication device 900 and the one or more other wireless communication devices can be established.

Further, the processor 902 of the wireless communication device 900 may be configured to: determine (1214) the scanning region of the transceiver 906 as a solid angle having an apex on the wireless communication device 900 smaller than a solid angle in which the transceiver 906 is configured to transmit and receive signals in the omnidirectional transmission mode.

Further, the processor 902 of the wireless communication device 900 may be configured to: determine (1216) the orientation by determining a point of view of the user based on an orientation of a head and/or one or more eyes of the user.

Further, the processor 902 of the wireless communication device 900 may be configured to: determine (1218) a signal strength of a signal received from one or more of the detected one or more other wireless communication devices; and determine (1218) one or more other detected wireless communication devices based on the one or more determined signal strengths.

Further, the processor 902 of the wireless communication device 900 may be configured to: determine (1220) the one or more signal strengths by determining a Received Signal Strength Indicator (RSSI) of a signal received from one or more of the detected one or more other wireless communication devices.

The signal received from one or more of the detected one or more other wireless communication devices may be a beacon message (cf., e.g., FIG. 5 and FIG. 6) from one or more of the detected one or more other wireless communication devices.

Further, the processor 902 of the wireless communication device 900 may be configured to: instruct (1222) the wireless communication device 900 to output the detected one or more other wireless communication devices to the user.

Further, the processor 902 of the wireless communication device 900 may be configured to: instruct (1224) the wireless communication device 900 to output the detected one or more other wireless communication devices and the associated determined signal strength for each of the detected one or more other wireless communication devices.

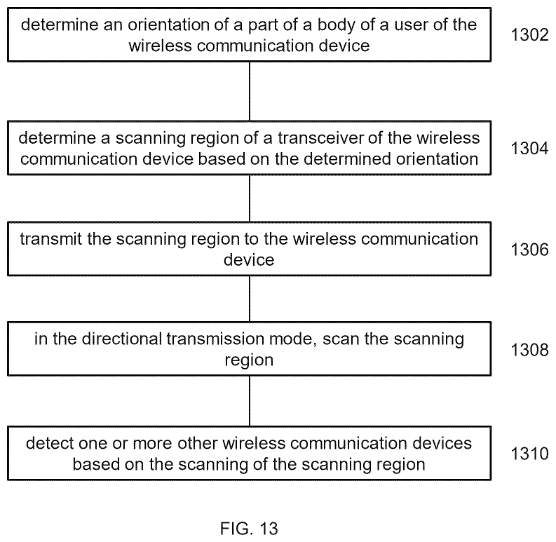

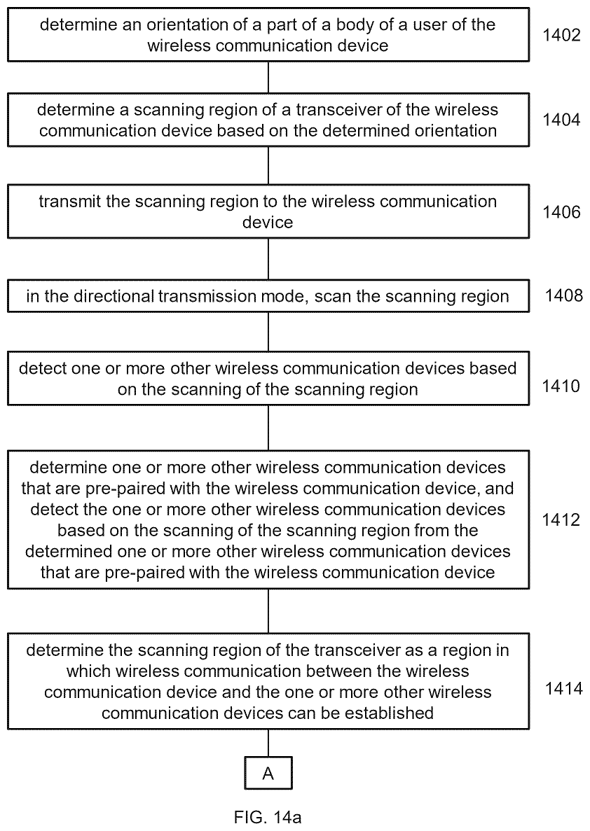

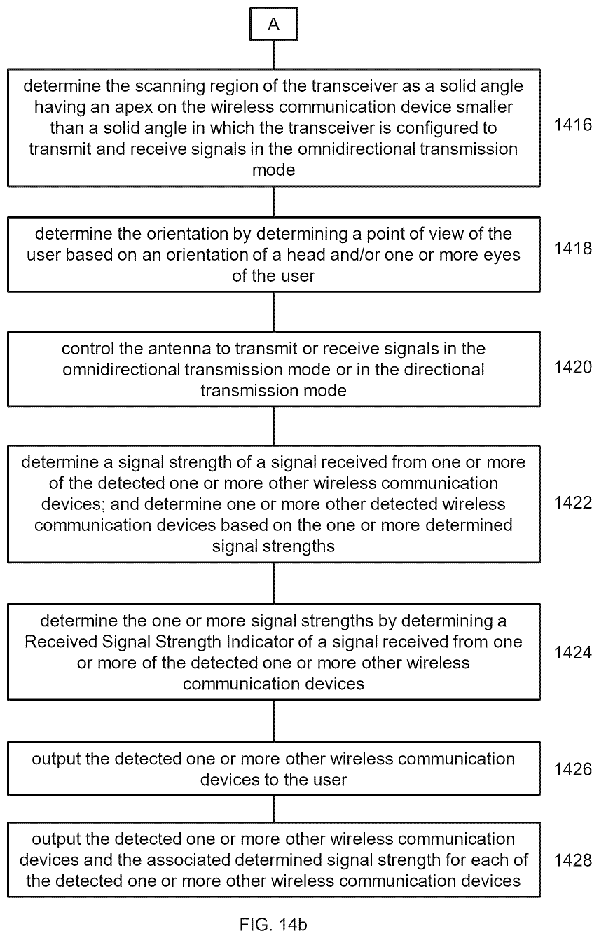

FIG. 13 shows steps of a method which a system 1000 is configured to carry out in accordance with various aspects of the present disclosure; FIG. 14a shows further steps of a method which the system 1000 is configured to carry out in accordance with various aspects of the present disclosure; and FIG. 14b is a continuation of FIG. 14a. As shown in FIG. 13, the processor 1004 of the system 1000 may be configured to: determine (1302) an orientation of a part of a body of a user of the wireless communication device 1002; determine (1304) a scanning region of a transceiver 1054 of the wireless communication device 1002 based on the determined orientation; and transmit (1306) the scanning region to the wireless communication device 1002. The wireless communication device 1002 (i.e., e.g., the processor 1050 of the wireless communication device 1002) may be configured to, in the directional transmission mode, scan (1308) the scanning region; and detect (1310) one or more other wireless communication devices based on the scanning of the scanning region.

As shown in FIG. 14a and FIG. 14b, the processor 1004 of the system 1000 may firstly be configured as shown in FIG. 13, i.e., to: determine (1402) an orientation of a part of a body of a user of the wireless communication device 1002; determine (1404) a scanning region of a transceiver 1054 of the wireless communication device 1002 based on the determined orientation; and transmit (1406) the scanning region to the wireless communication device 1002. Further, the wireless communication device 1002 (i.e., e.g., the processor 1050 of the wireless communication device 1002) may firstly be configured as shown in FIG. 13, i.e., to, in the directional transmission mode, scan (1408) the scanning region; and detect (1410) one or more other wireless communication devices based on the scanning of the scanning region.

Further, the wireless communication device 1002 (i.e., e.g., the processor 1050 of the wireless communication device 1002) may be configured to: determine (1412) one or more other wireless communication devices that are pre-paired with the wireless communication device 1002, and detect (1412) the one or more other wireless communication devices based on the scanning of the scanning region from the determined one or more other wireless communication devices that are pre-paired with the wireless communication device 1002.

Further, the wireless communication device 1002 (i.e., e.g., the processor 1050 of the wireless communication device 1002) may be configured to: determine (1414) the scanning region of the transceiver 1054 as a region in which wireless communication between the wireless communication device 1002 and the one or more other wireless communication devices can be established.

Further, the wireless communication device 1002 (i.e., e.g., the processor 1050 of the wireless communication device 1002) may be configured to: determine (1416) the scanning region of the transceiver 1054 as a solid angle having an apex on the wireless communication device 1002 smaller than a solid angle in which the transceiver 1054 is configured to transmit and receive signals in the omnidirectional transmission mode.

Further, the wireless communication device 1002 (i.e., e.g., the processor 1050 of the wireless communication device 1002) may be configured to: determine (1418) the orientation by determining a point of view of the user based on an orientation of a head and/or one or more eyes of the user.

Further, the transceiver 1054 may be configured to control (1420) the antenna 1058 to transmit or receive signals in the omnidirectional transmission mode or in the directional transmission mode.

Further, the wireless communication device 1002 (i.e., e.g., the processor 1050 of the wireless communication device 1002) may be configured to: determine (1422) a signal strength of a signal received from one or more of the detected one or more other wireless communication devices; and determine (1422) one or more other detected wireless communication devices based on the one or more determined signal strengths.

Further, the wireless communication device 1002 (i.e., e.g., the processor 1050 of the wireless communication device 1002) may be configured to: determine (1424) the one or more signal strengths by determining a Received Signal Strength Indicator (RSSI) of a signal received from one or more of the detected one or more other wireless communication devices. The signal received from one or more of the detected one or more other wireless communication devices may be a beacon message from one or more of the detected one or more other wireless communication devices.

Further, the wireless communication device 1002 (i.e., e.g., the processor 1050 of the wireless communication device 1002) may be configured to: output (1426) the detected one or more other wireless communication devices to the user.

Further, the wireless communication device 1002 (i.e., e.g., the processor 1050 of the wireless communication device 1002) may be configured to: output (1428) the detected one or more other wireless communication devices and the associated determined signal strength for each of the detected one or more other wireless communication devices.

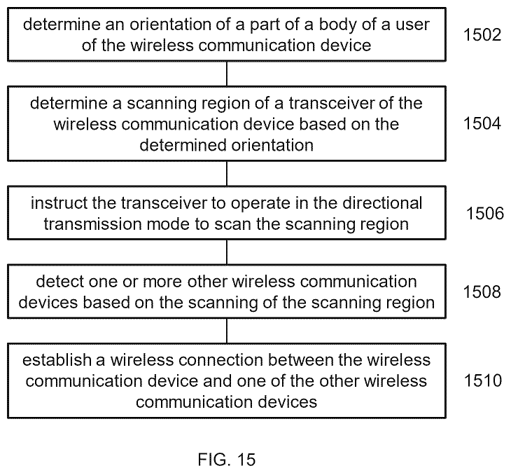

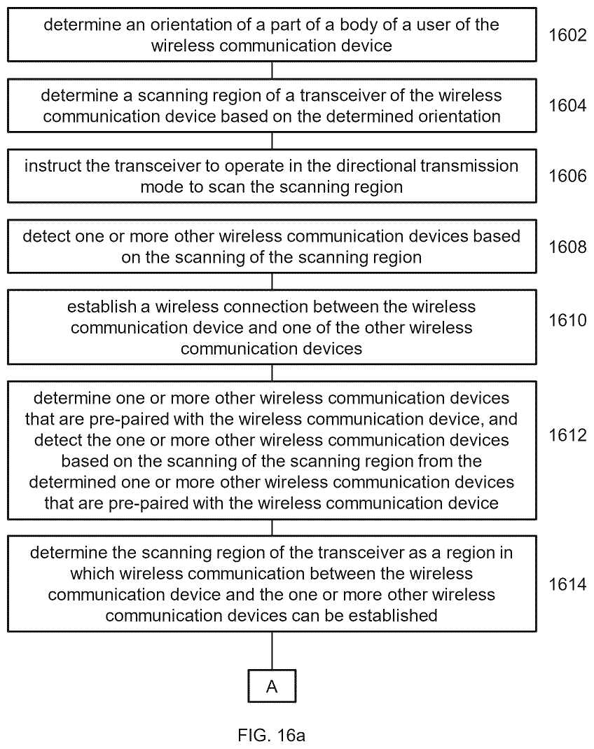

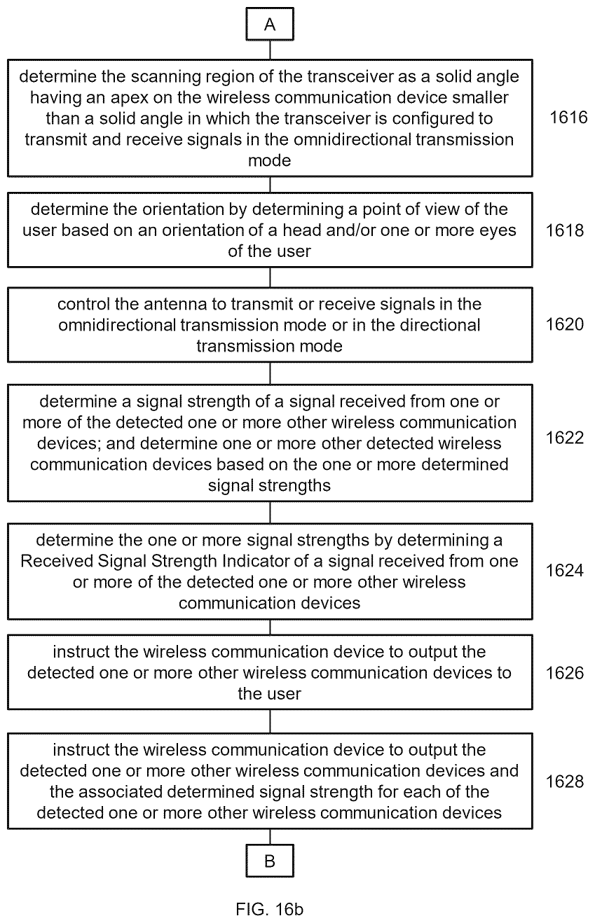

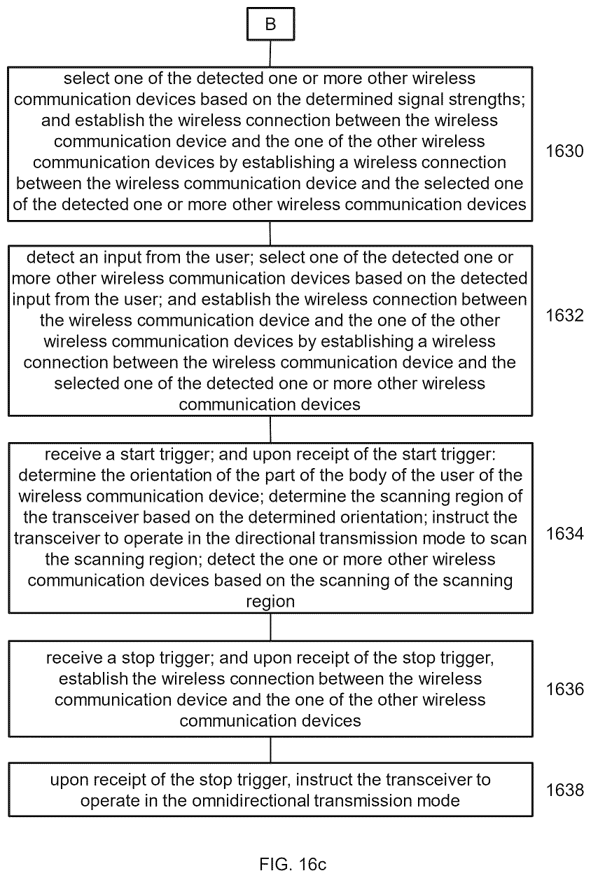

FIG. 15 shows steps of a method which a wireless communication device 900 is configured to carry out in accordance with various aspects of the present disclosure; FIG. 16a shows further steps of a method which the wireless communication device 900 is configured to carry in accordance with various aspects of the present disclosure;

FIG. 16b is a continuation of FIG. 16a; and FIG. 16c is a continuation of FIG. 16b. As shown in FIG. 15, the processor 902 of the wireless communication device 900 may be configured to: determine (1502) an orientation of a part of a body of a user of the wireless communication device 900; determine (1504) a scanning region of a transceiver 906 of the wireless communication device 900 based on the determined orientation; instruct (1506) the transceiver 906 to operate in the directional transmission mode to scan the scanning region; and detect (1508) one or more other wireless communication devices based on the scanning of the scanning region; and establish (1510) a wireless connection between the wireless communication device 900 and one of the other wireless communication devices.

As shown in FIG. 16a, FIG. 16b and FIG. 16c, the processor 902 of the wireless communication device 900 may firstly be configured as shown in FIG. 15, i.e., to: determine (1602) an orientation of a part of a body of a user of the wireless communication device 900; determine (1604) a scanning region of a transceiver 906 of the wireless communication device 900 based on the determined orientation; instruct (1606) the transceiver 906 to operate in the directional transmission mode to scan the scanning region; detect (1608) one or more other wireless communication devices based on the scanning of the scanning region; and establish (1610) a wireless connection between the wireless communication device 900 and one of the other wireless communication devices.

Further, the processor 902 of the wireless communication device 900 may be configured to: determine (1612) one or more other wireless communication devices that are pre-paired with the wireless communication device 900, and detect (1612) the one or more other wireless communication devices based on the scanning of the scanning region from the determined one or more other wireless communication devices that are pre-paired with the wireless communication device 900.

Further, the processor 902 of the wireless communication device 900 may be configured to: determine (1614) the scanning region of the transceiver 906 as a region in which wireless communication between the wireless communication device 900 and the one or more other wireless communication devices can be established.

Further, the processor 902 of the wireless communication device 900 may be configured to: determine (1616) the scanning region of the transceiver 906 as a solid angle having an apex on the wireless communication device 900 smaller than a solid angle in which the transceiver 906 is configured to transmit and receive signals in the omnidirectional transmission mode.

Further, the processor 902 of the wireless communication device 900 may be configured to: determine (1618) the orientation by determining a point of view of the user based on an orientation of a head and/or one or more eyes of the user.

Further, the transceiver may be configured to control (1620) the antenna 910 to transmit or receive signals in the omnidirectional transmission mode or in the directional transmission mode.

Further, the processor 902 of the wireless communication device 900 may be configured to: determine (1622) a signal strength of a signal received from one or more of the detected one or more other wireless communication devices; and determine (1622) one or more other detected wireless communication devices based on the one or more determined signal strengths.

Further, the processor 902 of the wireless communication device 900 may be configured to: determine (1624) the one or more signal strengths by determining a Received Signal Strength Indicator (RSSI) of a signal received from one or more of the detected one or more other wireless communication devices.

The signal received from one or more of the detected one or more other wireless communication devices may be a beacon message from one or more of the detected one or more other wireless communication devices.

Further, the processor 902 of the wireless communication device 900 may be configured to: instruct (1626) the wireless communication device 900 to output the detected one or more other wireless communication devices to the user.

Further, the processor 902 of the wireless communication device 900 may be configured to: instruct (1628) the wireless communication device 900 to output the detected one or more other wireless communication devices and the associated determined signal strength for each of the detected one or more other wireless communication devices.

Further, the processor 902 of the wireless communication device 900 may be configured to: select (1630) one of the detected one or more other wireless communication devices based on the determined signal strengths; and establish (1630) the wireless connection between the wireless communication device 900 and the one of the other wireless communication devices by establishing a wireless connection between the wireless communication device 900 and the selected one of the detected one or more other wireless communication devices.

Further, the processor 902 of the wireless communication device 900 may be configured to: detect (1632) an input from the user; select (1632) one of the detected one or more other wireless communication devices based on the detected input from the user; and establish (1632) the wireless connection between the wireless communication device 900 and the one of the other wireless communication devices by establishing a wireless connection between the wireless communication device 900 and the selected one of the detected one or more other wireless communication devices.

The processor 902 may be configured to detect (1632) the input from the user by determining an operation of the user interface 911.

Further, the processor 902 of the wireless communication device 900 may be configured to: receive (1634) a start trigger; and upon receipt of the start trigger: determine (1634) the orientation of the part of the body of the user of the wireless communication device 900; determine (1634) the scanning region of the transceiver 906 based on the determined orientation; instruct (1634) the transceiver 906 to operate in the directional transmission mode to scan the scanning region; and detect (1634) the one or more other wireless communication devices based on the scanning of the scanning region.

The processor 902 may be configured to receive (1634) the start trigger by determining an operation of the user interface 911.

Further, the processor 902 of the wireless communication device 900 may be configured to: receive (1636) a stop trigger; and upon receipt of the stop trigger, establish (1636) the wireless connection between the wireless communication device 900 and the one of the other wireless communication devices.

The processor 902 may be configured to receive (1636) the stop trigger by determining an operation of the user interface 911.

Further, the processor 902 of the wireless communication device 900 may be configured to: upon receipt of the stop trigger, instruct (1638) the transceiver 906 to operate in the omnidirectional transmission mode.

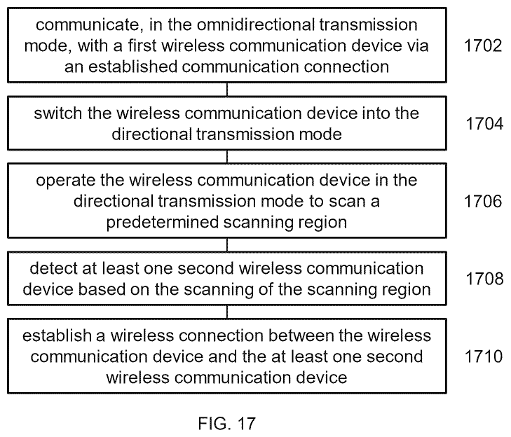

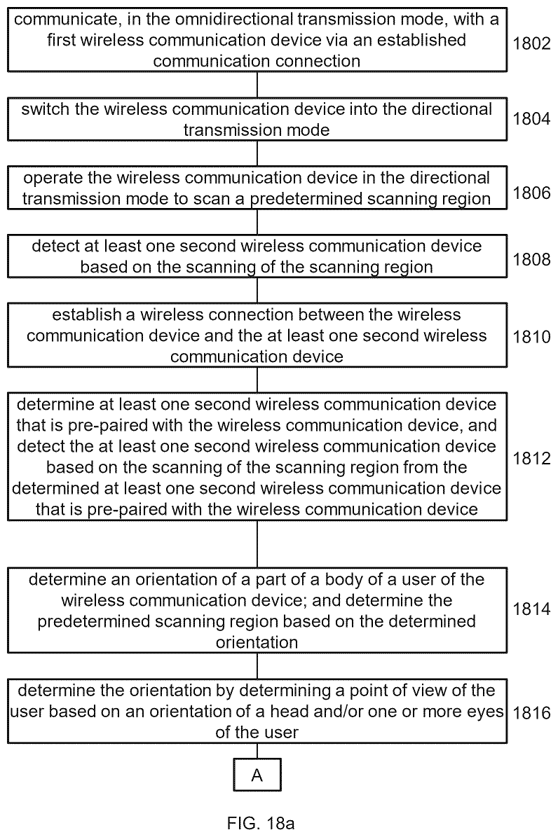

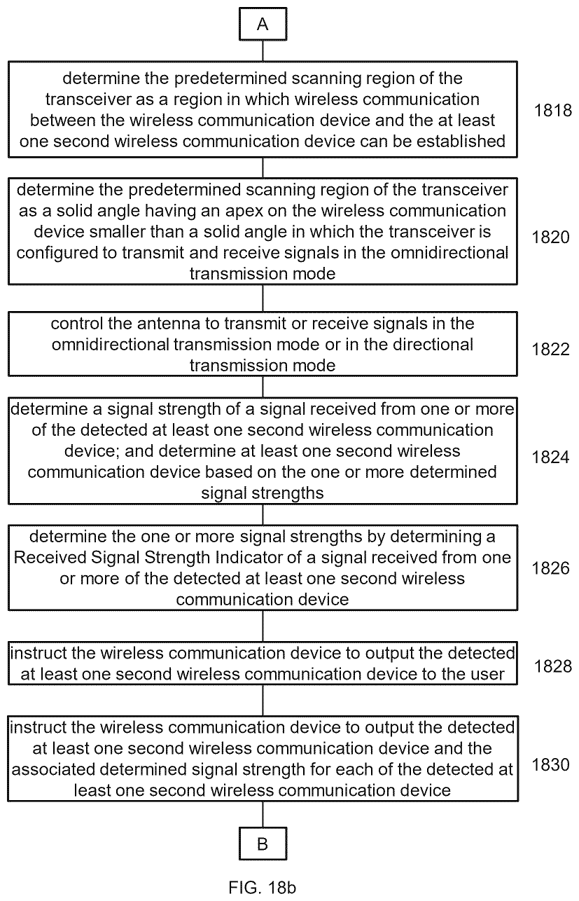

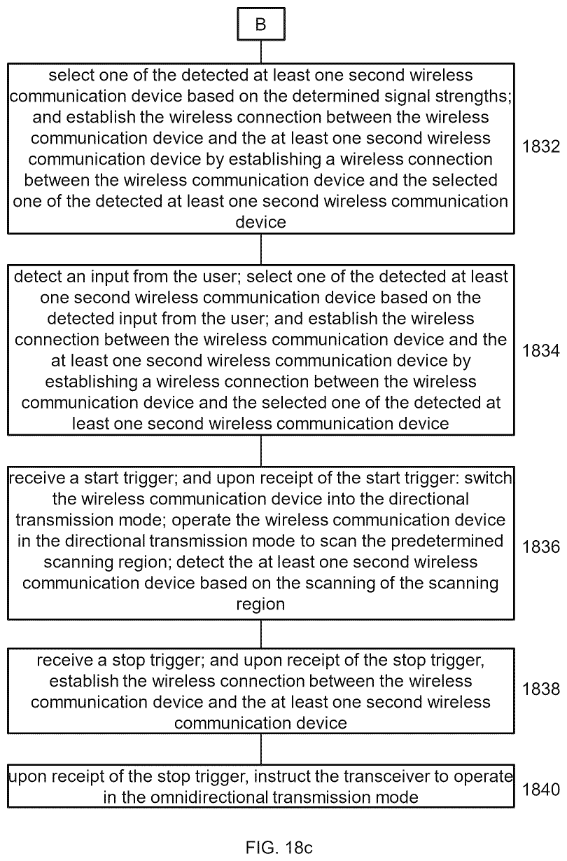

FIG. 17 shows steps of a method which a wireless communication device 900 is configured to carry out in accordance with various aspects of the present disclosure; FIG. 18a shows further steps of a method which the wireless communication device 900 is configured to carry out in accordance with various aspects of the present disclosure; FIG. 18b is a continuation of FIG. 18a; and FIG. 18c is a continuation of FIG. 18b. As shown in FIG. 17, the processor 902 of the wireless communication device 900 may be configured to: communicate (1702), in the omnidirectional transmission mode, with a first wireless communication device via an established communication connection; switch (1704) the wireless communication device 900 into the directional transmission mode; operate (1706) the wireless communication device 900 in the directional transmission mode to scan a predetermined scanning region; detect (1708) at least one second wireless communication device based on the scanning of the scanning region; and establish (1710) a wireless connection between the wireless communication device 900 and the at least one second wireless communication device.

As shown in FIG. 18a, FIG. 18b and FIG. 18c, the processor 902 of the wireless communication device 900 may firstly be configured as shown in FIG. 17, i.e., to: communicate (1802), in the omnidirectional transmission mode, with a first wireless communication device via an established communication connection; switch (1804) the wireless communication device 900 into the directional transmission mode; operate (1806) the wireless communication device 900 in the directional transmission mode to scan a predetermined scanning region; detect (1808) at least one second wireless communication device based on the scanning of the scanning region; and establish (1810) a wireless connection between the wireless communication device 900 and the at least one second wireless communication device.

Further, the processor 902 of the wireless communication device 900 may be configured to: determine (1812) at least one second wireless communication device that is pre-paired with the wireless communication device 900, and detect (1812) the at least one second wireless communication device based on the scanning of the scanning region from the determined at least one second wireless communication device that is pre-paired with the wireless communication device 900.

Further, the processor 902 of the wireless communication device 900 may be configured to: determine (1814) an orientation of a part of a body of a user of the wireless communication device 900; and determine (1814) the predetermined scanning region based on the determined orientation.

Further, the processor 902 of the wireless communication device 900 may be configured to: determine (1816) the orientation by determining a point of view of the user based on an orientation of a head and/or one or more eyes of the user.

Further, the processor 902 of the wireless communication device 900 may be configured to: determine (1818) the predetermined scanning region of the transceiver 906 as a region in which wireless communication between the wireless communication device 900 and the at least one second wireless communication device can be established.

Further, the processor 902 of the wireless communication device 900 may be configured to: determine (1820) the predetermined scanning region of the transceiver 906 as a solid angle having an apex on the wireless communication device 100 smaller than a solid angle in which the transceiver 906 is configured to transmit and receive signals in the omnidirectional transmission mode.

The transceiver 906 may be configured to control (1822) the antenna 910 to transmit or receive signals in the omnidirectional transmission mode or in the directional transmission mode.

Further, the processor 902 of the wireless communication device 900 may be configured to: determine (1824) a signal strength of a signal received from one or more of the detected at least one second wireless communication device; and determine (1824) at least one second wireless communication device based on the one or more determined signal strengths.

Further, the processor 902 of the wireless communication device 900 may be configured to: determine (1826) the one or more signal strengths by determining a Received Signal Strength Indicator (RSSI) of a signal received from one or more of the detected at least one second wireless communication device.

The signal received from one or more of the detected at least one second wireless communication device may be a beacon message from one or more of the detected at least one second wireless communication device.

Further, the processor 902 of the wireless communication device 900 may be configured to: instruct (1828) the wireless communication device 900 to output the detected at least one second wireless communication device to the user.

Further, the processor 902 of the wireless communication device 900 may be configured to: instruct (1830) the wireless communication device 900 to output the detected at least one second wireless communication device and the associated determined signal strength for each of the detected at least one second wireless communication device.

Further, the processor 902 of the wireless communication device 900 may be configured to: select (1832) one of the detected at least one second wireless communication device based on the determined signal strengths (e.g., select the one of the detected at least one second wireless communication device being determined to have a strongest signal strength among the detected at least one second wireless communication device); and establish (1832) the wireless connection between the wireless communication device 900 and the at least one second wireless communication device by establishing a wireless connection between the wireless communication device 900 and the selected one of the detected at least one second wireless communication device.

Further, the processor 902 of the wireless communication device 900 may be configured to: detect (1834) an input from the user; select (1834) one of the detected at least one second wireless communication device based on the detected input from the user; and establish (1834) the wireless connection between the wireless communication device 900 and the at least one second wireless communication device by establishing a wireless connection between the wireless communication device 900 and the selected one of the detected at least one second wireless communication device.

The processor 902 may be configured to detect (1834) the input from the user by determining an operation of the user interface 911.

Further, the processor 902 of the wireless communication device 900 may be configured to: receive (1836) a start trigger; and upon receipt of the start trigger: switch (1836) the wireless communication device 900 into the directional transmission mode; operate (1836) the wireless communication device 900 in the directional transmission mode to scan the predetermined scanning region; and detect (1836) the at least one second wireless communication device based on the scanning of the scanning region.

The processor 902 may be configured to receive (1836) the start trigger by determining an operation of the user interface 911.

Further, the processor 902 of the wireless communication device 900 may be configured to: receive (1838) a stop trigger; and upon receipt of the stop trigger, establish (1838) the wireless connection between the wireless communication device 900 and the at least one second wireless communication device.

The processor 902 may be configured to receive (1838) the stop trigger by determining an operation of the user interface 911. Further, the processor 902 of the wireless communication device 900 may be configured to: upon receipt of the stop trigger, instruct (1840) the transceiver 906 to operate in the omnidirectional transmission mode.

According to aspects of the disclosure, the wireless communication device 900, the wireless communication device 1002 and/or the system 1000 as described above may, e.g., comprise an audio output element (e.g., a loudspeaker), a graphics output element (e.g., a display), and/or an audio-graphics element for outputting the detected one or more other wireless communication devices to the user. The processor 902, 1004 or 1050 may be configured to instruct the wireless communication device 900 and/or the wireless communication device 1002 and/or the system 1000 to output the detected one or more other wireless communication devices to the user, e.g., via an audio message, a graphics message, a video message, and/or a combination thereof.

According to aspects of the disclosure, the wireless communication device 900, the wireless communication device 1002 and/or the system 1000 as described above may, e.g., be used for identifying and/or finding hidden other wireless communication devices, e.g., by outputting the detected one or more other wireless communication devices and/or by outputting the detected one or more other wireless communication devices and the associated determined signal strength for each of the detected one or more other wireless communication devices.

The scanning region as described above may be changed by the user, e.g., by changing the orientation of the part of the body of the user (e.g., by moving the part of the body) or by moving the body (e.g., towards one or more other wireless communication devices of interest).

The processor 902, the processor 1004 and/or the processor 1050 as described above may be configured to determine services provided by the one or more other wireless communication devices and/or a type of the one or more other wireless communication devices. Further, the processor 902, the processor 1004 and/or the processor 1050 as described above may be configured to instruct the wireless communication device 900 and/or the communication device 1002 to output the detected one or more other wireless communication devices to the user including, e.g., a type of the one or more other wireless communication devices and/or services provided by the one or more other wireless communication devices (cf., e.g., description of FIG. 5 and FIG. 6).

According to aspects of the disclosure, an orientation of a part of a body of a user as referred to above may, e.g., refer to a direction into which a user is looking (i.e., a direction of a head and/or one or more eyes of a user), a direction into which an arm, a hand and/or a finger of a user is pointing, a direction into which a leg, a foot and/or a toe of a user is pointing, and any direction of any part of a body of a user.

According to aspects of the disclosure, wireless communication devices may be referred to be “pre-paired”, e.g., if one wireless communication device is on a whitelist of another wireless communication device, i.e., e.g., if wireless communication devices have been paired in advance.

According to aspects of the disclosure, a processor configured to determine an orientation of a part of a body of a user of the wireless communication device may, e.g., be configured to determine the orientation of the part of the body of the user of the wireless communication device by determining a direction into which the wireless communication device (and/or a part of the wireless communication device, e.g., an antenna of the wireless communication device) is pointing when the wireless communication device is used (e.g., as intended) and/or worn (e.g., as intended) by the user. In this respect, e.g., headphones or smart glasses may have a direction into which they typically point when they are used (e.g., as intended).

According to aspects of the disclosure, a processor configured to determine an orientation of a part of a body of a user of the wireless communication device and/or an orientation of the wireless communication device may, e.g., be configured to determine the orientation of the part of the body of the user of the wireless communication device and/or the orientation of the wireless communication device by proximity sensing, e.g., by measuring heat, by measuring temperature, by measuring infrared radiation, by measuring RF interference, by measuring pressure, and/or the like.

According to aspects of the disclosure, a processor configured to determine a scanning region of a transceiver of the wireless communication device based on the determined orientation may, e.g., be configured to determine the scanning region of the transceiver by proximity sensing, e.g., by measuring heat, by measuring temperature, by measuring infrared radiation, by measuring RF interference, by measuring pressure, and/or the like.

According to aspects of the disclosure, as referred to in this application, the orientation of the part of the body of the user and/or the orientation of the wireless communication device may, e.g., be defined as a 3D direction (i.e., e.g., a direction in a three-dimensional space), a XYZ-direction (i.e., e.g., a direction in a three-dimensional space defined by XYZ-coordinates), geographic direction (e.g., north, e.g., south, e.g., west, e.g., east), an angular direction, a clockwise direction, a counterclockwise direction, a rotation direction, and the like.

Further, according to aspects of the disclosure, there may be provided a non-transitory computer readable storage medium storing instructions, that when executed by a processor, cause the processor to carry out the steps which, e.g., the processors 902, 1004, 1050 and/or the wireless communication device 1002 described above are configured to carry out.

Further, according to aspects of the disclosure, there may be provided a wireless communication device and/or a system including means for carrying out the steps which, e.g., the processors 902, 1004, 1050 and/or the wireless communication device 1002 described above are configured to carry out.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

Examples of aspects of the disclosure may be as follows:

Example 1: A wireless communication device configured to provide an omnidirectional transmission mode and a directional transmission mode, the wireless communication device comprising: a processor configured to: determine an orientation of a part of a body of a user of the wireless communication device; determine a scanning region of a transceiver of the wireless communication device based on the determined orientation; instruct the transceiver to operate in the directional transmission mode to scan the scanning region; and detect one or more other wireless communication devices based on the scanning of the scanning region.

Example 2: The wireless communication device of example 1, further comprising: the transceiver configured to provide the omnidirectional transmission mode and the directional transmission mode.

Example 3: The wireless communication device of any one of examples 1 or 2, further comprising: an antenna interface; wherein the processor is coupled to the antenna interface.

Example 4: The wireless communication device of any one of examples 1 to 3, wherein the processor is further configured to: determine one or more other wireless communication devices that are pre-paired with the wireless communication device, and detect the one or more other wireless communication devices based on the scanning of the scanning region from the determined one or more other wireless communication devices that are pre-paired with the wireless communication device.

Example 5: The wireless communication device of any one of examples 1 to 4, wherein the processor is further configured to: determine the scanning region of the transceiver as a region in which wireless communication between the wireless communication device and the one or more other wireless communication devices can be established.

Example 6: The wireless communication device of any one of examples 1 to 5, wherein the processor is further configured to: determine the scanning region of the transceiver as a solid angle having an apex on the wireless communication device smaller than a solid angle in which the transceiver is configured to transmit and receive signals in the omnidirectional transmission mode.

Example 7: The wireless communication device of any one of examples 1 to 6, wherein the processor is further configured to: determine the orientation by determining a point of view of the user based on an orientation of a head and/or one or more eyes of the Example 8: The wireless communication device of any one of examples 2 to 7, further comprising: an antenna coupled to the transceiver; wherein the transceiver is configured to control the antenna to transmit or receive signals in the omnidirectional transmission mode or in the directional transmission mode.

Example 9: The wireless communication device of any one of examples 1 to 8, wherein the processor is further configured to: determine a signal strength of a signal received from one or more of the detected one or more other wireless communication devices; and determine one or more other detected wireless communication devices based on the one or more determined signal strengths.

Example 10: The wireless communication device of example 9, wherein the processor is further configured to: determine the one or more signal strengths by determining a Received Signal Strength Indicator (RSSI) of a signal received from one or more of the detected one or more other wireless communication devices.

Example 11: The wireless communication device of any one of examples 9 to 10, wherein the signal received from one or more of the detected one or more other wireless communication devices is a beacon message from one or more of the detected one or more other wireless communication devices.

Example 12: The wireless communication device of any one of examples 1 to 11, wherein the processor is further configured to: instruct the wireless communication device to output the detected one or more other wireless communication devices to the user.

Example 13: The wireless communication device of any one of examples 9 to 11, wherein the processor is further configured to: instruct the wireless communication device to output the detected one or more other wireless communication devices and the associated determined signal strength for each of the detected one or more other wireless communication devices.

Example 14: The wireless communication device of any one of examples 1 to 13, wherein the wireless communication device is configured to operate according to a Bluetooth standard and/or a WiFi standard.

Example 15: A system, comprising: a wireless communication device configured to provide an omnidirectional transmission mode and a directional transmission mode; and a processor coupled to the wireless communication device and configured to: determine an orientation of a part of a body of a user of the wireless communication device; determine a scanning region of a transceiver of the wireless communication device based on the determined orientation; transmit the scanning region to the wireless communication device; wherein the wireless communication device is configured to, in the directional transmission mode, scan the scanning region; and wherein the wireless communication device is further configured to detect one or more other wireless communication devices based on the scanning of the scanning region.

Example 16: The system of example 15, wherein the wireless communication device further comprises: the transceiver configured to provide the omnidirectional transmission mode and the directional transmission mode.

Example 17: The system of any one of examples 15 to 16, wherein the wireless communication device is further configured to: determine one or more other wireless communication devices that are pre-paired with the wireless communication device; and detect the one or more other wireless communication devices based on the scanning of the scanning region from the determined one or more other wireless communication devices that are pre-paired with the wireless communication device.

Example 18: The system of any one of examples 15 to 17, wherein the wireless communication device is further configured to: determine the scanning region of the transceiver as a region in which wireless communication between the wireless communication device and the one or more other wireless communication devices can be established.

Example 19: The system of any one of examples 15 to 18, wherein the wireless communication device is further configured to: determine the scanning region of the transceiver as a solid angle having an apex on the wireless communication device smaller than a solid angle in which the transceiver is configured to transmit and receive signals in the omnidirectional transmission mode.

Example 20: The system of any one of examples 15 to 19, wherein the wireless communication device is further configured to: determine the orientation by determining a point of view of the user based on an orientation of a head and/or one or more eyes of the user.

Example 21: The system of any one of examples 16 to 20, wherein: the wireless communication device further comprises an antenna coupled to the transceiver; and wherein the transceiver is configured to control the antenna to transmit or receive signals in the omnidirectional transmission mode or in the directional transmission mode.

Example 22: The system of any one of examples 15 to 21, wherein the wireless communication device is further configured to: determine a signal strength of a signal received from one or more of the detected one or more other wireless communication devices; and determine one or more other detected wireless communication devices based on the one or more determined signal strengths.

Example 23: The system of example 22, wherein the wireless communication device is further configured to: determine the one or more signal strengths by determining a Received Signal Strength Indicator of a signal received from one or more of the detected one or more other wireless communication devices.

Example 24: The system of any one of examples 22 to 23, wherein the signal received from one or more of the detected one or more other wireless communication devices is a beacon message from one or more of the detected one or more other wireless communication devices.

Example 25: The system of any one of examples 15 to 24, wherein the wireless communication device is further configured to: output the detected one or more other wireless communication devices to the user.

Example 26: The system of any one of examples 15 to 24, wherein the wireless communication device is further configured to: output the detected one or more other wireless communication devices and the associated determined signal strength for each of the detected one or more other wireless communication devices.

Example 27: The system of any one of examples 15 to 26, wherein the wireless communication device is configured to operate according to a Bluetooth standard and/or a WiFi standard.

Example 28: A non-transitory computer readable storage medium storing instructions, that when executed by a processor, cause the processor to: determine an orientation of a part of a body of a user of a wireless communication device, the wireless communication device configured to provide an omnidirectional transmission mode and a directional transmission mode; determine a scanning region of a transceiver based on the determined orientation; instruct the transceiver to operate in the directional transmission mode to scan the scanning region; and detect one or more other wireless communication devices based on the scanning of the scanning region.

Example 29: The non-transitory computer readable storage medium of example 28, the wireless communication device further comprising: the transceiver configured to provide the omnidirectional transmission mode and the directional transmission mode.

Example 30: The non-transitory computer readable storage medium of any one of examples 28 to 29, the wireless communication device further comprising: an antenna interface; wherein the processor is coupled to the antenna interface.

Example 31: The non-transitory computer readable storage medium of any one of examples 28 to 30, wherein the instructions, when executed by the processor, further cause the processor to: determine one or more other wireless communication devices that are pre-paired with the wireless communication device, and detect the one or more other wireless communication devices based on the scanning of the scanning region from the determined one or more other wireless communication devices that are pre-paired with the wireless communication device.

Example 32: The non-transitory computer readable storage medium of any one of examples 28 to 31, wherein the instructions, when executed by the processor, further cause the processor to: determine the scanning region of the transceiver as a region in which wireless communication between the wireless communication device and the one or more other wireless communication devices can be established.

Example 33: The non-transitory computer readable storage medium of any one of examples 28 to 32, wherein the instructions, when executed by the processor, further cause the processor to: determine the scanning region of the transceiver as a solid angle having an apex on the wireless communication device smaller than a solid angle in which the transceiver is configured to transmit and receive signals in the omnidirectional transmission mode.

Example 34: The non-transitory computer readable storage medium of any one of examples 28 to 33, wherein the instructions, when executed by the processor, further cause the processor to: determine the orientation by determining a point of view of the user based on an orientation of a head and/or one or more eyes of the user.

Example 35: The non-transitory computer readable storage medium of any one of examples 29 to 34, the wireless communication device further comprising: an antenna coupled to the transceiver; wherein the transceiver is configured to control the antenna to transmit or receive signals in the omnidirectional transmission mode or in the directional transmission mode.

Example 36: The non-transitory computer readable storage medium of any one of examples 28 to 35, wherein the instructions, when executed by the processor, further cause the processor to: determine a signal strength of a signal received from one or more of the detected one or more other wireless communication devices; and determine one or more other detected wireless communication devices based on the one or more determined signal strengths.

Example 37: The non-transitory computer readable storage medium of example 36, wherein the instructions, when executed by the processor, further cause the processor to: determine the one or more signal strengths by determining a Received Signal Strength Indicator of a signal received from one or more of the detected one or more other wireless communication devices.

Example 38: The non-transitory computer readable storage medium of any one of examples 36 to 37, wherein the signal received from one or more of the detected one or more other wireless communication devices is a beacon message from one or more of the detected one or more other wireless communication devices.

Example 39: The non-transitory computer readable storage medium of any one of examples 28 to 38, wherein the instructions, when executed by the processor, further cause the processor to: instruct the wireless communication device to output the detected one or more other wireless communication devices to the user.

Example 40: The non-transitory computer readable storage medium of any one of examples 36 to 38, wherein the instructions, when executed by the processor, further cause the processor to: instruct the wireless communication device to output the detected one or more other wireless communication devices and the associated determined signal strength for each of the detected one or more other wireless communication devices.

Example 41: The wireless communication device of any one of examples 28 to 40, wherein the wireless communication device is configured to operate according to a Bluetooth standard and/or a WiFi standard.

Example 42: A non-transitory computer readable storage medium storing instructions, that when executed by a processor, cause the processor to: determine an orientation of a part of a body of a user of a wireless communication device, the wireless communication device configured to provide an omnidirectional transmission mode and a directional transmission mode; determine a scanning region of a transceiver of the wireless communication device based on the determined orientation; and transmit the scanning region to the wireless communication device; wherein the wireless communication device is configured to, in the directional transmission mode, scan the scanning region; and wherein the wireless communication device is further configured to detect one or more other wireless communication devices based on the scanning of the scanning region.

Example 43: The non-transitory computer readable storage medium of example 42, wherein the wireless communication device further comprises: the transceiver configured to provide the omnidirectional transmission mode and the directional transmission mode.

Example 44: The non-transitory computer readable storage medium of any one of examples 42 to 43, wherein the wireless communication device is further configured to: determine one or more other wireless communication devices that are pre-paired with the wireless communication device, and detect the one or more other wireless communication devices based on the scanning of the scanning region from the determined one or more other wireless communication devices that are pre-paired with the wireless communication device.

Example 45: The non-transitory computer readable storage medium of any one of examples 42 to 44, wherein the wireless communication device is further configured to: determine the scanning region of the transceiver as a region in which wireless communication between the wireless communication device and the one or more other wireless communication devices can be established.

Example 46: The non-transitory computer readable storage medium of any one of examples 42 to 45, wherein the wireless communication device is further configured to: determine the scanning region of the transceiver as a solid angle having an apex on the wireless communication device smaller than a solid angle in which the transceiver is configured to transmit and receive signals in the omnidirectional transmission mode.

Example 47: The non-transitory computer readable storage medium of any one of examples 42 to 46, wherein the wireless communication device is further configured to: determine the orientation by determining a point of view of the user based on an orientation of a head and/or one or more eyes of the user.

Example 48: The non-transitory computer readable storage medium of any one of examples 42 to 47, wherein: the wireless communication device further comprises an antenna coupled to the transceiver; and wherein the transceiver is configured to control the antenna to transmit or receive signals in the omnidirectional transmission mode or in the directional transmission mode.

Example 49: The non-transitory computer readable storage medium of any one of examples 42 to 48, wherein the wireless communication device is further configured to: determine a signal strength of a signal received from one or more of the detected one or more other wireless communication devices; and determine one or more other detected wireless communication devices based on the one or more determined signal strengths.

Example 50: The non-transitory computer readable storage medium of example 49, wherein the wireless communication device is further configured to: determine the one or more signal strengths by determining a Received Signal Strength Indicator of a signal received from one or more of the detected one or more other wireless communication devices.

Example 51: The non-transitory computer readable storage medium of any one of examples 49 to 50, wherein the signal received from one or more of the detected one or more other wireless communication devices is a beacon message from one or more of the detected one or more other wireless communication devices.

Example 52: The non-transitory computer readable storage medium of any one of examples 42 to 51, wherein the wireless communication device is further configured to: output the detected one or more other wireless communication devices to the user.

Example 53: The non-transitory computer readable storage medium of any one of examples 42 to 51, wherein the wireless communication device is further configured to: output the detected one or more other wireless communication devices and the associated determined signal strength for each of the detected one or more other wireless communication devices.

Example 54: The non-transitory computer readable storage medium of any one of examples 42 to 53, wherein the wireless communication device is configured to operate according to a Bluetooth standard and/or a WiFi standard.

Example 55: A wireless communication device configured to provide an omnidirectional transmission mode and a directional transmission mode, the wireless communication device comprising: a means for determining an orientation of a part of a body of a user of the wireless communication device; a means for determining a scanning region of a transceiver of the wireless communication device based on the determined orientation; a means for instructing the transceiver to operate in the directional transmission mode to scan the scanning region; and a means for detecting one or more other wireless communication devices based on the scanning of the scanning region.

Example 56: The wireless communication device of example 55, further comprising: the transceiver configured to provide the omnidirectional transmission mode and the directional transmission mode.

Example 57: The wireless communication device of any one of examples 55 or 56, further comprising: an antenna interface; wherein the processor is coupled to the antenna interface.

Example 58: The wireless communication device of any one of examples 55 to 57, further comprising: a means for determining one or more other wireless communication devices that are pre-paired with the wireless communication device, and a means for detecting the one or more other wireless communication devices based on the scanning of the scanning region from the determined one or more other wireless communication devices that are pre-paired with the wireless communication device.

Example 59: The wireless communication device of any one of examples 55 to 58, further comprising: a means for determining the scanning region of the transceiver as a region in which wireless communication between the wireless communication device and the one or more other wireless communication devices can be established.

Example 60: The wireless communication device of any one of examples 55 to 59, further comprising: a means for determining the scanning region of the transceiver as a solid angle having an apex on the wireless communication device smaller than a solid angle in which the transceiver is configured to transmit and receive signals in the omnidirectional transmission mode.

Example 61: The wireless communication device of any one of examples 55 to 60, further comprising: a means for determining the orientation by determining a point of view of the user based on an orientation of a head and/or one or more eyes of the user.

Example 62: The wireless communication device of any one of examples 56 to 61, further comprising: an antenna coupled to the transceiver; wherein the transceiver is configured to control the antenna to transmit or receive signals in the omnidirectional transmission mode or in the directional transmission mode.

Example 63: The wireless communication device of any one of examples 55 to 62, further comprising: a means for determining a signal strength of a signal received from one or more of the detected one or more other wireless communication devices; and a means for determining one or more other detected wireless communication devices based on the one or more determined signal strengths.

Example 64: The wireless communication device of example 63, further comprising: a means for determining the one or more signal strengths by determining a Received Signal Strength Indicator of a signal received from one or more of the detected one or more other wireless communication devices.

Example 65: The wireless communication device of any one of examples 63 to 64, wherein the signal received from one or more of the detected one or more other wireless communication devices is a beacon message from one or more of the detected one or more other wireless communication devices.

Example 66: The wireless communication device of any one of examples 55 to 65, further comprising: a means for instructing the wireless communication device to output the detected one or more other wireless communication devices to the user.

Example 67: The wireless communication device of any one of examples 63 to 65, further comprising: a means for instructing the wireless communication device to output the detected one or more other wireless communication devices and the associated determined signal strength for each of the detected one or more other wireless communication devices.

Example 68: The wireless communication device of any one of examples 55 to 67, wherein the wireless communication device is configured to operate according to a Bluetooth standard and/or a WiFi standard.

Example 69: A system, comprising: a wireless communication device configured to provide an omnidirectional transmission mode and a directional transmission mode; a means for determining an orientation of a part of a body of a user of the wireless communication device; a means for determining a scanning region of a transceiver of the wireless communication device based on the determined orientation; a means for transmitting the scanning region to the wireless communication device; wherein the wireless communication device is configured to, in the directional transmission mode, scan the scanning region; and wherein the wireless communication device is further configured to detect one or more other wireless communication devices based on the scanning of the scanning region.

Example 70: The system of example 69, wherein the wireless communication device further comprises: the transceiver configured to provide the omnidirectional transmission mode and the directional transmission mode.

Example 71: The system of any one of examples 69 to 70, wherein the wireless communication device is further configured to: determine one or more other wireless communication devices that are pre-paired with the wireless communication device, and detect the one or more other wireless communication devices based on the scanning of the scanning region from the determined one or more other wireless communication devices that are pre-paired with the wireless communication device.

Example 72: The system of any one of examples 69 to 71, wherein the wireless communication device is further configured to: determine the scanning region of the transceiver as a region in which wireless communication between the wireless communication device and the one or more other wireless communication devices can be established.

Example 73: The system of any one of examples 69 to 72, wherein the wireless communication device is further configured to: determine the scanning region of the transceiver as a solid angle having an apex on the wireless communication device smaller than a solid angle in which the transceiver is configured to transmit and receive signals in the omnidirectional transmission mode.

Example 74: The system of any one of examples 69 to 73, wherein the wireless communication device is further configured to: determine the orientation by determining a point of view of the user based on an orientation of a head and/or one or more eyes of the Example 75: The system of any one of examples 70 to 74, wherein: the wireless communication device further comprises an antenna coupled to the transceiver; and wherein the transceiver is configured to control the antenna to transmit or receive signals in the omnidirectional transmission mode or in the directional transmission mode.

Example 76: The system of any one of examples 69 to 75, wherein the wireless communication device is further configured to determine a signal strength of a signal received from one or more of the detected one or more other wireless communication devices; and determine one or more other detected wireless communication devices based on the one or more determined signal strengths.

Example 77: The system of example 76, wherein the wireless communication device is further configured to: determine the one or more signal strengths by determining a Received Signal Strength Indicator of a signal received from one or more of the detected one or more other wireless communication devices.

Example 78: The system of any one of examples 76 to 77, wherein the signal received from one or more of the detected one or more other wireless communication devices is a beacon message from one or more of the detected one or more other wireless communication devices.

Example 79: The system of any one of examples 69 to 78, wherein the wireless communication device is further configured to: output the detected one or more other wireless communication devices to the user.

Example 80: The system of any one of examples 69 to 78, wherein the wireless communication device is further configured to: output the detected one or more other wireless communication devices and the associated determined signal strength for each of the detected one or more other wireless communication devices.

Example 81: The system of any one of examples 69 to 80, wherein the wireless communication device is configured to operate according to a Bluetooth standard and/or a WiFi standard.

Example 82: A wireless communication device configured to provide an omnidirectional transmission mode and a directional transmission mode, the wireless communication device comprising: a processor configured to: determine an orientation of a part of a body of a user of the wireless communication device; determine a scanning region of a transceiver of the wireless communication device based on the determined orientation; instruct the transceiver to operate in the directional transmission mode to scan the scanning region; detect one or more other wireless communication devices based on the scanning of the scanning region; and establish a wireless connection between the wireless communication device and one of the other wireless communication devices.

Example 83: The wireless communication device of example 82, further comprising: the transceiver configured to provide the omnidirectional transmission mode and the directional transmission mode.

Example 84: The wireless communication device of any one of examples 82 to 83, further comprising: an antenna interface; wherein the processor is coupled to the antenna interface.

Example 85: The wireless communication device of any one of examples 82 to 84, wherein the processor is further configured to: determine one or more other wireless communication devices that are pre-paired with the wireless communication device, and detect the one or more other wireless communication devices based on the scanning of the scanning region from the determined one or more other wireless communication devices that are pre-paired with the wireless communication device.

Example 86: The wireless communication device of any one of examples 82 to 85, wherein the processor is further configured to: determine the scanning region of the transceiver as a region in which wireless communication between the wireless communication device and the one or more other wireless communication devices can be established.

Example 87: The wireless communication device of any one of examples 82 to 86, wherein the processor is further configured to: determine the scanning region of the transceiver as a solid angle having an apex on the wireless communication device smaller than a solid angle in which the transceiver is configured to transmit and receive signals in the omnidirectional transmission mode.

Example 88: The wireless communication device of any one of examples 82 to 87, wherein the processor is further configured to: determine the orientation by determining a point of view of the user based on an orientation of a head and/or one or more eyes of the user.

Example 89: The wireless communication device of any one of examples 83 to 88, further comprising: an antenna coupled to the transceiver; wherein the transceiver is configured to control the antenna to transmit or receive signals in the omnidirectional transmission mode or in the directional transmission mode.

Example 90: The wireless communication device of any one of examples 82 to 89, wherein the processor is further configured to: determine a signal strength of a signal received from one or more of the detected one or more other wireless communication devices; and determine one or more other detected wireless communication devices based on the one or more determined signal strengths.

Example 91: The wireless communication device of example 90, wherein the processor is further configured to: determine the one or more signal strengths by determining a Received Signal Strength Indicator of a signal received from one or more of the detected one or more other wireless communication devices.

Example 92: The wireless communication device of any one of examples 90 to 91, wherein the signal received from one or more of the detected one or more other wireless communication devices is a beacon message from one or more of the detected one or more other wireless communication devices.

Example 93: The wireless communication device of any one of examples 82 to 92, wherein the processor is further configured to: instruct the wireless communication device to output the detected one or more other wireless communication devices to the user.

Example 94: The wireless communication device of any one of examples 90 to 92, wherein the processor is further configured to: instruct the wireless communication device to output the detected one or more other wireless communication devices and the associated determined signal strength for each of the detected one or more other wireless communication devices.

Example 95: The wireless communication device of any one of examples 90 to 94, wherein the processor is further configured to: select one of the detected one or more other wireless communication devices based on the determined signal strengths; and establish the wireless connection between the wireless communication device and the one of the other wireless communication devices by establishing a wireless connection between the wireless communication device and the selected one of the detected one or more other wireless communication devices.

Example 96: The wireless communication device of any one of examples 82 to 94, wherein the processor is further configured to: detect an input from the user; select one of the detected one or more other wireless communication devices based on the detected input from the user; and establish the wireless connection between the wireless communication device and the one of the other wireless communication devices by establishing a wireless connection between the wireless communication device and the selected one of the detected one or more other wireless communication devices.

Example 97: The wireless communication device of any one of examples 82 to 96, wherein the processor is further configured to: receive a start trigger; and upon receipt of the start trigger: determine the orientation of the part of the body of the user of the wireless communication device; determine the scanning region of the transceiver based on the determined orientation; instruct the transceiver to operate in the directional transmission mode to scan the scanning region; and detect the one or more other wireless communication devices based on the scanning of the scanning region.

Example 98: The wireless communication device of any one of examples 82 to 97, wherein the processor is further configured to: receive a stop trigger; and upon receipt of the stop trigger, establish the wireless connection between the wireless communication device and the one of the other wireless communication devices.

Example 99: The wireless communication device of example 98, wherein the processor is further configured to: upon receipt of the stop trigger, instruct the transceiver to operate in the omnidirectional transmission mode.

Example 100: The wireless communication device of any one of examples 82 to 99, wherein the wireless communication device is configured to operate according to a Bluetooth standard and/or a WiFi standard.

Example 101: A non-transitory computer readable storage medium storing instructions, that when executed by a processor, cause the processor to: determine an orientation of a part of a body of a user of a wireless communication device, the wireless communication device configured to provide an omnidirectional transmission mode and a directional transmission mode; determine a scanning region of a transceiver of the wireless communication device based on the determined orientation; instruct the transceiver to operate in the directional transmission mode to scan the scanning region; detect one or more other wireless communication devices based on the scanning of the scanning region; and establish a wireless connection between the wireless communication device and one of the other wireless communication devices.

Example 102: The non-transitory computer readable storage medium of example 101, the wireless communication device further comprising: the transceiver configured to provide the omnidirectional transmission mode and the directional transmission mode.

Example 103: The non-transitory computer readable storage medium of any one of examples 101 to 102, the wireless communication device further comprising: an antenna interface; wherein the processor is coupled to the antenna interface.

Example 104: The non-transitory computer readable storage medium of any one of examples 101 to 103, wherein the instructions, when executed by the processor, further cause the processor to: determine one or more other wireless communication devices that are pre-paired with the wireless communication device, and detect the one or more other wireless communication devices based on the scanning of the scanning region from the determined one or more other wireless communication devices that are pre-paired with the wireless communication device.

Example 105: The non-transitory computer readable storage medium of any one of examples 101 to 104, wherein the instructions, when executed by the processor, further cause the processor to: determine the scanning region of the transceiver as a region in which wireless communication between the wireless communication device and the one or more other wireless communication devices can be established.

Example 106: The non-transitory computer readable storage medium of any one of examples 101 to 105, wherein the instructions, when executed by the processor, further cause the processor to: determine the scanning region of the transceiver as a solid angle having an apex on the wireless communication device smaller than a solid angle in which the transceiver is configured to transmit and receive signals in the omnidirectional transmission mode.

Example 107: The non-transitory computer readable storage medium of any one of examples 101 to 106, wherein the instructions, when executed by the processor, further cause the processor to: determine the orientation by determining a point of view of the user based on an orientation of a head and/or one or more eyes of the user.

Example 108: The non-transitory computer readable storage medium of any one of examples 102 to 107, the wireless communication device further comprising: an antenna coupled to the transceiver; wherein the transceiver is configured to control the antenna to transmit or receive signals in the omnidirectional transmission mode or in the directional transmission mode.

Example 109: The non-transitory computer readable storage medium of any one of examples 101 to 108, wherein the instructions, when executed by the processor, further cause the processor to: determine a signal strength of a signal received from one or more of the detected one or more other wireless communication devices; and determine one or more other detected wireless communication devices based on the one or more determined signal strengths.

Example 110: The non-transitory computer readable storage medium of example 109, wherein the instructions, when executed by the processor, further cause the processor to: determine the one or more signal strengths by determining a Received Signal Strength Indicator of a signal received from one or more of the detected one or more other wireless communication devices.

Example 111: The non-transitory computer readable storage medium of any one of examples 109 to 110, wherein the signal received from one or more of the detected one or more other wireless communication devices is a beacon message from one or more of the detected one or more other wireless communication devices.

Example 112: The non-transitory computer readable storage medium of any one of examples 101 to 111, wherein the instructions, when executed by the processor, further cause the processor to: instruct the wireless communication device to output the detected one or more other wireless communication devices to the user.

Example 113: The non-transitory computer readable storage medium of any one of examples 109 to 111, wherein the instructions, when executed by the processor, further cause the processor to: instruct the wireless communication device to output the detected one or more other wireless communication devices and the associated determined signal strength for each of the detected one or more other wireless communication devices.

Example 114: The non-transitory computer readable storage medium of any one of examples 109 to 113, wherein the instructions, when executed by the processor, further cause the processor to: select one of the detected one or more other wireless communication devices based on the determined signal strengths; and establish the wireless connection between the wireless communication device and the one of the other wireless communication devices by establishing a wireless connection between the wireless communication device and the selected one of the detected one or more other wireless communication devices.

Example 115: The non-transitory computer readable storage medium of any one of examples 101 to 113, wherein the instructions, when executed by the processor, further cause the processor to: detect an input from the user; select one of the detected one or more other wireless communication devices based on the detected input from the user; and establish the wireless connection between the wireless communication device and the one of the other wireless communication devices by establishing a wireless connection between the wireless communication device and the selected one of the detected one or more other wireless communication devices.

Example 116: The non-transitory computer readable storage medium of any one of examples 101 to 115, wherein the instructions, when executed by the processor, further cause the processor to: receive a start trigger; and upon receipt of the start trigger: determine the orientation of the part of the body of the user of the wireless communication device; determine the scanning region of the transceiver based on the determined orientation; instruct the transceiver to operate in the directional transmission mode to scan the scanning region; and detect the one or more other wireless communication devices based on the scanning of the scanning region.

Example 117: The non-transitory computer readable storage medium of any one of examples 101 to 116, wherein the instructions, when executed by the processor, further cause the processor to: receive a stop trigger; and upon receipt of the stop trigger, establish the wireless connection between the wireless communication device and the one of the other wireless communication devices.

Example 118: The non-transitory computer readable storage medium of example 117, wherein the instructions, when executed by the processor, further cause the processor to: upon receipt of the stop trigger, instruct the transceiver to operate in the omnidirectional transmission mode.

Example 119: The non-transitory computer readable storage medium of any one of examples 101 to 118, wherein the wireless communication device is configured to operate according to a Bluetooth standard and/or a WiFi standard.

Example 120: A wireless communication device configured to provide an omnidirectional transmission mode and a directional transmission mode, the wireless communication device comprising: a means for determining an orientation of a part of a body of a user of the wireless communication device; a means for determining a scanning region of a transceiver of the wireless communication device based on the determined orientation; a means for instructing the transceiver to operate in the directional transmission mode to scan the scanning region; a means for detecting one or more other wireless communication devices based on the scanning of the scanning region; and a means for establishing a wireless connection between the wireless communication device and one of the other wireless communication devices.

Example 121: The wireless communication device of example 120, further comprising: the transceiver configured to provide the omnidirectional transmission mode and the directional transmission mode.

Example 122: The wireless communication device of any one of examples 120 to 121, further comprising: an antenna interface; wherein the processor is coupled to the antenna interface.

Example 123: The wireless communication device of any one of examples 120 to 122, further comprising: a means for determining one or more other wireless communication devices that are pre-paired with the wireless communication device, and a means for detecting the one or more other wireless communication devices based on the scanning of the scanning region from the determined one or more other wireless communication devices that are pre-paired with the wireless communication device.

Example 124: The wireless communication device of any one of examples 120 to 123, further comprising: a means for determining the scanning region of the transceiver as a region in which wireless communication between the wireless communication device and the one or more other wireless communication devices can be established.

Example 125: The wireless communication device of any one of examples 120 to 124, further comprising: a means for determining the scanning region of the transceiver as a solid angle having an apex on the wireless communication device smaller than a solid angle in which the transceiver is configured to transmit and receive signals in the omnidirectional transmission mode.

Example 126: The wireless communication device of any one of examples 120 to 125, further comprising: a means for determining the orientation by determining a point of view of the user based on an orientation of a head and/or one or more eyes of the user.

Example 127: The wireless communication device of any one of examples 121 to 126, further comprising: an antenna coupled to the transceiver; wherein the transceiver is configured to control the antenna to transmit or receive signals in the omnidirectional transmission mode or in the directional transmission mode.

Example 128: The wireless communication device of any one of examples 120 to 127, further comprising: a means for determining a signal strength of a signal received from one or more of the detected one or more other wireless communication devices; and a means for determining one or more other detected wireless communication devices based on the one or more determined signal strengths.

Example 129: The wireless communication device of example 128, further comprising: a means for determining the one or more signal strengths by determining a Received Signal Strength Indicator of a signal received from one or more of the detected one or more other wireless communication devices.

Example 130: The wireless communication device of any one of examples 128 to 129, wherein the signal received from one or more of the detected one or more other wireless communication devices is a beacon message from one or more of the detected one or more other wireless communication devices.

Example 131: The wireless communication device of any one of examples 120 to 130, further comprising: a means for instructing the wireless communication device to output the detected one or more other wireless communication devices to the user.

Example 132: The wireless communication device of any one of examples 128 to 130, further comprising: a means for instructing the wireless communication device to output the detected one or more other wireless communication devices and the associated determined signal strength for each of the detected one or more other wireless communication devices.

Example 133: The wireless communication device of any one of examples 128 to 132, further comprising: a means for selecting one of the detected one or more other wireless communication devices based on the determined signal strengths; and a means for establishing the wireless connection between the wireless communication device and the one of the other wireless communication devices by establishing a wireless connection between the wireless communication device and the selected one of the detected one or more other wireless communication devices.

Example 134: The wireless communication device of any one of examples 120 to 132, further comprising: a means for detecting an input from the user; a means for selecting one of the detected one or more other wireless communication devices based on the detected input from the user; and a means for establishing the wireless connection between the wireless communication device and the one of the other wireless communication devices by establishing a wireless connection between the wireless communication device and the selected one of the detected one or more other wireless communication devices.

Example 135: The wireless communication device of any one of examples 120 to 134, further comprising a means for: receiving a start trigger; and upon receipt of the start trigger: determining the orientation of the part of the body of the user of the wireless communication device; determining the scanning region of the transceiver based on the determined orientation; instructing the transceiver to operate in the directional transmission mode to scan the scanning region; and detecting the one or more other wireless communication devices based on the scanning of the scanning region.

Example 136: The wireless communication device of any one of examples 120 to 135, further comprising a means for: receiving a stop trigger; and upon receipt of the stop trigger, establishing the wireless connection between the wireless communication device and the one of the other wireless communication devices.

Example 137: The wireless communication device of example 136, further comprising a means for: upon receipt of the stop trigger, instructing the transceiver to operate in the omnidirectional transmission mode.

Example 138: The wireless communication device of any one of examples 120 to 137, wherein the wireless communication device is configured to operate according to a Bluetooth standard and/or a WiFi standard.

Example 139: A wireless communication device configured to provide an omnidirectional transmission mode and a directional transmission mode, the wireless communication device comprising: a processor configured to: communicate, in the omnidirectional transmission mode, with a first wireless communication device via an established communication connection; switch the wireless communication device into the directional transmission mode; operate the wireless communication device in the directional transmission mode to scan a predetermined scanning region; detect at least one second wireless communication device based on the scanning of the scanning region; and establish a wireless connection between the wireless communication device and the at least one second wireless communication device.

Example 140: The wireless communication device of example 139, further comprising: the transceiver configured to provide the omnidirectional transmission mode and the directional transmission mode.

Example 141: The wireless communication device of any one of examples 139 to 140, further comprising: an antenna interface; wherein the processor is coupled to the antenna interface.

Example 142: The wireless communication device of any one of examples 139 to 141, wherein the processor is further configured to: determine at least one second wireless communication device that is pre-paired with the wireless communication device, and detect the at least one second wireless communication device based on the scanning of the scanning region from the determined at least one second wireless communication device that is pre-paired with the wireless communication device.

Example 143: The wireless communication device of any one of examples 139 to 142, wherein the processor is further configured to: determine an orientation of a part of a body of a user of the wireless communication device; and determine the predetermined scanning region based on the determined orientation.

Example 144: The wireless communication device of example 143, wherein the processor is further configured to: determine the orientation by determining a point of view of the user based on an orientation of a head and/or one or more eyes of the user.

Example 145: The wireless communication device of any one of examples 139 to 144, wherein the processor is further configured to: determine the predetermined scanning region of the transceiver as a region in which wireless communication between the wireless communication device and the at least one second wireless communication device can be established.

Example 146: The wireless communication device of any one of examples 139 to 145, wherein the processor is further configured to: determine the predetermined scanning region of the transceiver as a solid angle having an apex on the wireless communication device smaller than a solid angle in which the transceiver is configured to transmit and receive signals in the omnidirectional transmission mode.

Example 147: The wireless communication device of any one of examples 140 to 146, further comprising: an antenna coupled to the transceiver; wherein the transceiver is configured to control the antenna to transmit or receive signals in the omnidirectional transmission mode or in the directional transmission mode.

Example 148: The wireless communication device of any one of examples 139 to 147, wherein the processor is further configured to: determine a signal strength of a signal received from one or more of the detected at least one second wireless communication device; and determine at least one second wireless communication device based on the one or more determined signal strengths.

Example 149: The wireless communication device of example 148, wherein the processor is further configured to: determine the one or more signal strengths by determining a Received Signal Strength Indicator of a signal received from one or more of the detected at least one second wireless communication device.

Example 150: The wireless communication device of any one of examples 148 to 149, wherein the signal received from one or more of the detected at least one second wireless communication device is a beacon message from one or more of the detected at least one second wireless communication device.

Example 151: The wireless communication device of any one of examples 139 to 150, wherein the processor is further configured to: instruct the wireless communication device to output the detected at least one second wireless communication device to the user.

Example 152: The wireless communication device of any one of examples 148 to 150, wherein the processor is further configured to: instruct the wireless communication device to output the detected at least one second wireless communication device and the associated determined signal strength for each of the detected at least one second wireless communication device.

Example 153: The wireless communication device of any one of examples 148 to 152, wherein the processor is further configured to: select one of the detected at least one second wireless communication device based on the determined signal strengths; and establish the wireless connection between the wireless communication device and the at least one second wireless communication device by establishing a wireless connection between the wireless communication device and the selected one of the detected at least one second wireless communication device.

Example 154: The wireless communication device of any one of examples 139 to 152, wherein the processor is further configured to: detect an input from the user; select one of the detected at least one second wireless communication device based on the detected input from the user; and establish the wireless connection between the wireless communication device and the at least one second wireless communication device by establishing a wireless connection between the wireless communication device and the selected one of the detected at least one second wireless communication device.

Example 155: The wireless communication device of any one of examples 139 to 154, wherein the processor is further configured to: receive a start trigger; and upon receipt of the start trigger: switch the wireless communication device into the directional transmission mode; operate the wireless communication device in the directional transmission mode to scan the predetermined scanning region; and detect the at least one second wireless communication device based on the scanning of the scanning region.

Example 156: The wireless communication device of any one of examples 139 to 155, wherein the processor is further configured to: receive a stop trigger; and upon receipt of the stop trigger, establish the wireless connection between the wireless communication device and the at least one second wireless communication device.

Example 157: The wireless communication device of example 156, wherein the processor is further configured to: upon receipt of the stop trigger, instruct the transceiver to operate in the omnidirectional transmission mode.

Example 158: The wireless communication device of any one of examples 139 to 157, wherein the wireless communication device is configured to operate according to a Bluetooth standard and/or a WiFi standard.

Example 159: A non-transitory computer readable storage medium storing instructions, that when executed by a processor, cause the processor to: communicate, in the omnidirectional transmission mode, with a first wireless communication device, the wireless communication device configured to provide an omnidirectional transmission mode and a directional transmission mode, via an established communication connection; switch the wireless communication device into the directional transmission mode; operate the wireless communication device in the directional transmission mode to scan a predetermined scanning region; detect at least one second wireless communication device based on the scanning of the scanning region; and establish a wireless connection between the wireless communication device and the at least one second wireless communication device.

Example 160: The non-transitory computer readable storage medium of example 159, the wireless communication device further comprising: the transceiver configured to provide the omnidirectional transmission mode and the directional transmission mode.

Example 161: The non-transitory computer readable storage medium of any one of examples 159 to 160, the wireless communication device further comprising: an antenna interface; wherein the processor is coupled to the antenna interface.

Example 162: The non-transitory computer readable storage medium of any one of examples 139 to 141, wherein the instructions, when executed by the processor, further cause the processor to: determine at least one second wireless communication device that is pre-paired with the wireless communication device, and detect the at least one second wireless communication device based on the scanning of the scanning region from the determined at least one second wireless communication device that is pre-paired with the wireless communication device.

Example 163: The non-transitory computer readable storage medium of any one of examples 159 to 162, wherein the instructions, when executed by the processor, further cause the processor to: determine an orientation of a part of a body of a user of the wireless communication device; and determine the predetermined scanning region based on the determined orientation.

Example 164: The non-transitory computer readable storage medium of example 163, wherein the instructions, when executed by the processor, further cause the processor to: determine the orientation by determining a point of view of the user based on an orientation of a head and/or one or more eyes of the user.

Example 165: The non-transitory computer readable storage medium of any one of examples 159 to 164, wherein the instructions, when executed by the processor, further cause the processor to: determine the predetermined scanning region of the transceiver as a region in which wireless communication between the wireless communication device and the at least one second wireless communication device can be established.

Example 166: The non-transitory computer readable storage medium of any one of examples 159 to 165, wherein the instructions, when executed by the processor, further cause the processor to: determine the predetermined scanning region of the transceiver as a solid angle having an apex on the wireless communication device smaller than a solid angle in which the transceiver is configured to transmit and receive signals in the omnidirectional transmission mode.

Example 167: The non-transitory computer readable storage medium of any one of examples 160 to 166, the wireless communication device further comprising: an antenna coupled to the transceiver; wherein the transceiver is configured to control the antenna to transmit or receive signals in the omnidirectional transmission mode or in the directional transmission mode.

Example 168: The non-transitory computer readable storage medium of any one of examples 159 to 167, wherein the instructions, when executed by the processor, further cause the processor to: determine a signal strength of a signal received from one or more of the detected at least one second wireless communication device; and determine at least one second wireless communication device based on the one or more determined signal strengths.

Example 169: The non-transitory computer readable storage medium of example 168, wherein the instructions, when executed by the processor, further cause the processor to: determine the one or more signal strengths by determining a Received Signal Strength Indicator of a signal received from one or more of the detected at least one second wireless communication device.

Example 170: The non-transitory computer readable storage medium of any one of examples 168 to 169, wherein the signal received from one or more of the detected at least one second wireless communication device is a beacon message from one or more of the detected at least one second wireless communication device.

Example 171: The non-transitory computer readable storage medium of any one of examples 159 to 170, wherein the instructions, when executed by the processor, further cause the processor to: instruct the wireless communication device to output the detected at least one second wireless communication device to the user.

Example 172: The non-transitory computer readable storage medium of any one of examples 168 to 170, wherein the instructions, when executed by the processor, further cause the processor to: instruct the wireless communication device to output the detected at least one second wireless communication device and the associated determined signal strength for each of the detected at least one second wireless communication device.

Example 173: The non-transitory computer readable storage medium of any one of examples 168 to 172, wherein the instructions, when executed by the processor, further cause the processor to: select one of the detected at least one second wireless communication device based on the determined signal strengths; and establish the wireless connection between the wireless communication device and the at least one second wireless communication device by establishing a wireless connection between the wireless communication device and the selected one of the detected at least one second wireless communication device.

Example 174: The non-transitory computer readable storage medium of any one of examples 159 to 172, wherein the instructions, when executed by the processor, further cause the processor to: detect an input from the user; select one of the detected at least one second wireless communication device based on the detected input from the user; and establish the wireless connection between the wireless communication device and the at least one second wireless communication device by establishing a wireless connection between the wireless communication device and the selected one of the detected at least one second wireless communication device.

Example 175: The non-transitory computer readable storage medium of any one of examples 159 to 174, wherein the instructions, when executed by the processor, further cause the processor to: receive a start trigger; and upon receipt of the start trigger: switch the wireless communication device into the directional transmission mode; operate the wireless communication device in the directional transmission mode to scan the predetermined scanning region; and detect the at least one second wireless communication device based on the scanning of the scanning region.

Example 176: The non-transitory computer readable storage medium of any one of examples 159 to 175, wherein the instructions, when executed by the processor, further cause the processor to: receive a stop trigger; and upon receipt of the stop trigger, establish the wireless connection between the wireless communication device and the at least one second wireless communication device.

Example 177: The non-transitory computer readable storage medium of example 176, wherein the instructions, when executed by the processor, further cause the processor to: upon receipt of the stop trigger, instruct the transceiver to operate in the omnidirectional transmission mode.

Example 178: The non-transitory computer readable storage medium of any one of examples 159 to 177, wherein the wireless communication device is configured to operate according to a Bluetooth standard and/or a WiFi standard.

Example 179: A wireless communication device configured to provide an omnidirectional transmission mode and a directional transmission mode, the wireless communication device comprising: a means for communicating, in the omnidirectional transmission mode, with a first wireless communication device via an established communication connection; a means for switching the wireless communication device into the directional transmission mode; a means for operating the wireless communication device in the directional transmission mode to scan a predetermined scanning region; a means for detecting at least one second wireless communication device based on the scanning of the scanning region; and a means for establishing a wireless connection between the wireless communication device and the at least one second wireless communication device

Example 180: The wireless communication device of example 179, further comprising: the transceiver configured to provide the omnidirectional transmission mode and the directional transmission mode.

Example 181: The wireless communication device of any one of examples 179 to 180, further comprising: an antenna interface; wherein the processor is coupled to the antenna interface.

Example 182: The wireless communication device of any one of examples 179 to 181, further comprising: a means for determining at least one second wireless communication device that is pre-paired with the wireless communication device; and a means for detecting the at least one second wireless communication device based on the scanning of the scanning region from the determined at least one second wireless communication device that is pre-paired with the wireless communication device.

Example 183: The wireless communication device of any one of examples 179 to 182, further comprising: a means for determining an orientation of a part of a body of a user of the wireless communication device; and a means for determining the predetermined scanning region based on the determined orientation.

Example 184: The wireless communication device of example 183, further comprising: a means for determining the orientation by determining a point of view of the user based on an orientation of a head and/or one or more eyes of the user.

Example 185: The wireless communication device of any one of examples 179 to 184, further comprising: a means for determining the predetermined scanning region of the transceiver as a region in which wireless communication between the wireless communication device and the at least one second wireless communication device can be established.

Example 186: The wireless communication device of any one of examples 179 to 185, further comprising: a means for determining the predetermined scanning region of the transceiver as a solid angle having an apex on the wireless communication device smaller than a solid angle in which the transceiver is configured to transmit and receive signals in the omnidirectional transmission mode.

Example 187: The wireless communication device of any one of examples 180 to 186, further comprising: an antenna coupled to the transceiver; wherein the transceiver is configured to control the antenna to transmit or receive signals in the omnidirectional transmission mode or in the directional transmission mode.

Example 188: The wireless communication device of any one of examples 179 to 187, further comprising: a means for determining a signal strength of a signal received from one or more of the detected at least one second wireless communication device; and a means for determining at least one second wireless communication device based on the one or more determined signal strengths.

Example 189: The wireless communication device of example 188, further comprising: a means for determining the one or more signal strengths by determining a Received Signal Strength Indicator of a signal received from one or more of the detected at least one second wireless communication device.

Example 190: The wireless communication device of any one of examples 188 to 189, wherein the signal received from one or more of the detected at least one second wireless communication device is a beacon message from one or more of the detected at least one second wireless communication device.

Example 191: The wireless communication device of any one of examples 179 to 190, further comprising: a means for instructing the wireless communication device to output the detected at least one second wireless communication device to the user.

Example 192: The wireless communication device of any one of examples 188 to 190, further comprising: a means for instructing the wireless communication device to output the detected at least one second wireless communication device and the associated determined signal strength for each of the detected at least one second wireless communication device.

Example 193: The wireless communication device of any one of examples 188 to 192, further comprising: a means for selecting one of the detected at least one second wireless communication device based on the determined signal strengths; and a means for establishing the wireless connection between the wireless communication device and the at least one second wireless communication device by establishing a wireless connection between the wireless communication device and the selected one of the detected at least one second wireless communication device.

Example 194: The wireless communication device of any one of examples 189 to 192, further comprising: a means for detecting an input from the user; a means for selecting one of the detected at least one second wireless communication device based on the detected input from the user; and a means for establishing the wireless connection between the wireless communication device and the at least one second wireless communication device by establishing a wireless connection between the wireless communication device and the selected one of the detected at least one second wireless communication device.

Example 195: The wireless communication device of any one of examples 189 to 194, further comprising a means for: receiving a start trigger; and upon receipt of the start trigger: switching the wireless communication device into the directional transmission mode; operating the wireless communication device in the directional transmission mode to scan the predetermined scanning region; and detecting the at least one second wireless communication device based on the scanning of the scanning region.

Example 196: The wireless communication device of any one of examples 189 to 195, further comprising a means for: receiving a stop trigger; and upon receipt of the stop trigger, establishing the wireless connection between the wireless communication device and the at least one second wireless communication device.

Example 197: The wireless communication device of example 196, further comprising a means for: upon receipt of the stop trigger, instructing the transceiver to operate in the omnidirectional transmission mode.

Example 198: The wireless communication device of any one of examples 189 to 197, wherein the wireless communication device is configured to operate according to a Bluetooth standard and/or a WiFi standard.

What is claimed is:

1. A wireless communication device configured to provide an omnidirectional transmission mode and a directional transmission mode, the wireless communication device comprising:
a processor configured to:
determine an orientation of a part of a body of a user of the wireless communication device;
determine a scanning region of a transceiver of the wireless communication device based on the determined orientation;
instruct the transceiver to operate in the directional transmission mode to scan the scanning region; and
detect one or more other wireless communication devices based on the scanning of the scanning region.

2. The wireless communication device of claim 1, further comprising:
the transceiver configured to provide the omnidirectional transmission mode and the directional transmission mode.

3. The wireless communication device of claim 1, wherein the processor is further configured to:
determine one or more other wireless communication devices that are pre-paired with the wireless communication device, and detect the one or more other wireless communication devices based on the scanning of the scanning region from the determined one or more other wireless communication devices that are pre-paired with the wireless communication device.

4. The wireless communication device of claim 1, wherein the processor is further configured to:
determine the scanning region of the transceiver as a region in which wireless communication between the wireless communication device and the one or more other wireless communication devices can be established.

5. The wireless communication device of claim 1, wherein the processor is further configured to:
determine the scanning region of the transceiver as a solid angle having an apex on the wireless communication device smaller than a solid angle in which the transceiver is configured to transmit and receive signals in the omnidirectional transmission mode.

6. The wireless communication device of claim 1, wherein the processor is further configured to:
determine the orientation by determining a point of view of the user based on an orientation of a head and/or one or more eyes of the user.

7. The wireless communication device of claim 1, wherein the processor is further configured to:
determine a signal strength of a signal received from one or more of the detected one or more other wireless communication devices; and
determine one or more other detected wireless communication devices based on the one or more determined signal strengths.

8. The wireless communication device of claim 7, wherein the processor is further configured to:
determine the one or more signal strengths by determining a Received Signal Strength Indicator of a signal received from one or more of the detected one or more other wireless communication devices.

9. The wireless communication device of claim 7, wherein the processor is further configured to:
instruct the wireless communication device to output the detected one or more other wireless communication devices and the associated determined signal strength for each of the detected one or more other wireless communication devices.

10. The wireless communication device of claim 1, wherein the processor is further configured to:
instruct the wireless communication device to output the detected one or more other wireless communication devices to the user.

11. The wireless communication device of claim 1, wherein the wireless communication device is configured to operate according to a Bluetooth standard and/or a WiFi standard.

12. A wireless communication device configured to provide an omnidirectional transmission mode and a directional transmission mode, the wireless communication device comprising:
a processor configured to:
determine an orientation of a part of a body of a user of the wireless communication device;
determine a scanning region of a transceiver of the wireless communication device based on the determined orientation;
instruct the transceiver to operate in the directional transmission mode to scan the scanning region;
detect one or more other wireless communication devices based on the scanning of the scanning region; and
establish a wireless connection between the wireless communication device and one of the other wireless communication devices.

13. The wireless communication device of claim 12, wherein the processor is further configured to:
determine the orientation by determining a point of view of the user based on an orientation of a head and/or one or more eyes of the user.

14. The wireless communication device of claim 12, wherein the processor is further configured to:
determine a signal strength of a signal received from one or more of the detected one or more other wireless communication devices; and
determine one or more other detected wireless communication devices based on the one or more determined signal strengths.

15. The wireless communication device of claim 14, wherein the processor is further configured to:
select one of the detected one or more other wireless communication devices based on the determined signal strengths; and
establish the wireless connection between the wireless communication device and the one of the other wireless communication devices by establishing a wireless connection between the wireless device and the selected one of the detected one or more other wireless communication devices.

16. The wireless communication device of claim 12, wherein the processor is further configured to:
detect an input from the user;
select one of the detected one or more other wireless communication devices based on the detected input from the user; and
establish the wireless connection between the wireless communication device and the one of the other wireless communication devices by establishing a wireless connection between the wireless communication device and the selected one of the detected one or more other wireless communication devices.

17. The wireless communication device of claim 12, wherein the processor is further configured to:
receive a start trigger; and
upon receipt of the start trigger:
determine the orientation of the part of the body of the user of the wireless communication device;
determine the scanning region of the transceiver based on the determined orientation;
instruct the transceiver to operate in the directional transmission mode to scan the scanning region; and
detect the one or more other wireless communication devices based on the scanning of the scanning region.

18. The wireless communication device of claim 12, wherein the processor is further configured to:
receive a stop trigger; and
upon receipt of the stop trigger, establish the wireless connection between the wireless communication device and the one of the other wireless communication devices.

19. The wireless communication device of claim 18, wherein the processor is further configured to:
upon receipt of the stop trigger, instruct the transceiver to operate in the omnidirectional transmission mode.

20. A wireless communication device configured to provide an omnidirectional transmission mode and a directional transmission mode, the wireless communication device comprising:
a processor configured to:
determine an orientation of the wireless communication device;
determine a scanning region of a transceiver of the wireless communication device based on the determined orientation;
instruct the transceiver to operate in the directional transmission mode to scan the scanning region; and
detect one or more other wireless communication devices based on the scanning of the scanning region.
